(19) United States
(12) Patent Application Publication
(10) Pub. No.: US 2017/0078697 A1
(43) Pub. Date: Mar. 16, 2017

(54) DEPTH IMAGE PREDICTION MODE TRANSMISSION METHOD AND APPARATUS FOR ENCODING AND DECODING INTER-LAYER VIDEO

(71) Applicant: SAMSUNG ELECTRONICS CO., LTD., Suwon-si (KR)

(72) Inventors: Jin-young LEE, Suwon-si (KR); Byeong-doo CHOI, Suwon-si (KR); Min-woo PARK, Yongin-si (KR); Yong-jin CHO, Seoul (KR)

(73) Assignee: SAMSUNG ELECTRONICS CO., LTD., Suwon-si (KR)

(21) Appl. No.: 15/125,277

(22) PCT Filed: Mar. 11, 2015
(86) PCT No.: PCT/KR2015/002375

§ 371 Date: Sep. 12, 2016

Related U.S. Application Data
(60) Provisional application No. 61/951,049, filed on Mar. 11, 2014.

(51) Int. Cl. H04N 19/597; H04N 19/119; H04N 19/187

(52) U.S. Cl. CPC H04N 19/597; H04N 19/187; H04N 19/119

(57) ABSTRACT

Provided is an inter-layer video decoding method including: obtaining prediction mode information of a depth image; generating a prediction block of a current block forming the depth image, based on the obtained prediction mode information; and decoding the depth image by using the prediction block, wherein the obtaining of the prediction mode information includes obtaining a first flag, which indicates whether the depth image allows a method of predicting the depth image by splitting blocks forming the depth image into at least two partitions using a wedgelet as a boundary, and a second flag, which indicates whether the depth image allows a method of predicting the depth image by splitting the blocks forming the depth image into at least two partitions using a contour as a boundary.

### TECHNICAL FIELD

The present disclosure relates to inter-layer video encoding and decoding methods, and more particularly, to encoding and decoding methods with respect to a prediction mode of a depth image.

### BACKGROUND ART

A stereoscopic image is a 3-dimensional (3D) image providing shape information about a depth and a space at the same time with image information. In a stereo-image, different views are provided to the left and right eyes, whereas in a stereoscopic image, an image is provided so that the image appears to be viewed from a different direction whenever the observer changes his or her view. Accordingly, in order to generate the stereoscopic image, images captured in different views are required.

The images captured in different views in order to generate the stereoscopic image have massive amounts of data. Accordingly, considering a network infrastructure, terrestrial bandwidth, etc. for the stereoscopic image, it is nearly impossible to compress the stereoscopic image even by using an encoding apparatus suitable for single-view video coding, such as MPEG-2, H.264/AVC, or HEVC.

Accordingly, a multi-view (multi-layer) image encoding apparatus suitable for generating a stereoscopic image is required. Specifically, technology for efficiently reducing time and view redundancy needs to be developed.

For example, in a multi-view video codec, compressibility may be increased by compressing a base view by using single-view video compression and encoding an enhancement view by referring to the base view. Also, by additionally encoding auxiliary data, such as a depth image, images of more views than views input from a decoder may be generated. Here, the depth image is used rather than directly shown to a user but to compose images of intermediate views, and when the depth image deteriorates, the quality of the composed images is also reduced. Accordingly, in the multi-view video codec, not only a multi-view video but also a depth image needs to be efficiently compressed.

### ADVANTAGEOUS EFFECTS

According to inter-layer video decoding and encoding apparatuses and methods according to embodiments, a prediction mode of a depth image may be efficiently encoded or decoded, thereby reducing complexity of the inter-layer video decoding and encoding apparatuses and effectively generating an image of a composite view.

Additional aspects will be set forth in part in the description which follows and, in part, will be apparent from the description, or may be learned by practice of the presented exemplary embodiments.

### DESCRIPTION OF THE DRAWINGS

FIG. 1A is a block diagram of an inter-layer video encoding apparatus, according to an embodiment.

FIG. 1B is a flowchart of a video encoding method according to an embodiment.

FIG. 2A is a block diagram of an inter-layer video decoding apparatus according to an embodiment.

FIG. 2B is a flowchart of a video decoding method according to an embodiment.

FIG. 3 illustrates an inter-layer prediction structure according to an embodiment.

FIG. 4 illustrates sequence parameter set (SPS) 3-dimensional (3D) expansion syntax according to an embodiment.

FIG. 5 illustrates coding-unit syntax according to an embodiment.

FIG. 6 illustrates intra-mode-ext syntax receiving a depth modeling mode (DMM) parameter.

FIG. 7 is a block diagram of a video encoding apparatus based on coding units having a tree structure, according to an embodiment.

FIG. 8 is a block diagram of a video decoding apparatus based on coding units having a tree structure, according to an embodiment.

FIG. 9 is a diagram for describing a concept of coding units according to an embodiment.

FIG. 10 is a block diagram of an image encoder based on coding units, according to an embodiment.

FIG. 11 is a block diagram of an image decoder based on coding units, according to an embodiment.

FIG. 12 is a diagram illustrating deeper coding units and partitions, according to an embodiment.

FIG. 13 is a diagram for describing a relationship between a coding unit and transformation units, according to an embodiment.

FIG. 14 is a diagram for describing encoding information of deeper coding units, according to an embodiment.

FIG. 15 is a diagram of deeper coding units according to an embodiment.

FIGS. 16 through 18 are diagrams for describing a relationship between coding units, prediction units, and transformation units, according to an embodiment.

FIG. 19 is a diagram for describing a relationship between a coding unit, a prediction unit, and a transformation unit, according to encoding mode information of Table 1.

FIG. 20 is a diagram of a physical structure of a disc in which a program is stored, according to an embodiment.

FIG. 21 is a diagram of a disc drive for recording and reading a program by using a disc.

FIG. 22 is a diagram of an overall structure of a content supply system for providing a content distribution service.

FIGS. 23 and 24 are diagrams of an external structure and an internal structure of a mobile phone to which a video encoding method and a video decoding method are applied, according to an embodiment.

FIG. 25 is a diagram of a digital broadcast system to which a communication system is applied, according to the present disclosure.

FIG. 26 is a diagram illustrating a network structure of a cloud computing system using a video encoding apparatus and a video decoding apparatus, according to an embodiment.

### BEST MODE

According to an aspect of an embodiment, an inter-layer video decoding method includes: obtaining prediction mode information of a depth image; generating a prediction block of a current block forming the depth image, based on the obtained prediction mode information; and decoding the depth image by using the prediction block, wherein the obtaining of the prediction mode information includes obtaining a first flag, which indicates whether the depth image allows a method of predicting the depth image by splitting blocks forming the depth image into at least two partitions using a wedgelet as a boundary, and a second flag, which indicates whether the depth image allows a method of predicting the depth image by splitting the blocks forming the depth image into at least two partitions using a contour as a boundary.

The obtaining of the prediction mode information may include further obtaining, from the first flag, information about whether the depth image allows a method of predicting the depth image by using an intra simplified depth coding (SDC) mode.

The obtaining of the prediction mode information may further include obtaining a third flag including information about whether the depth image allows a method of predicting the depth image by using an inter SDC mode.

The obtaining of the prediction mode information may include: when the first flag has a value of 1,determining that the depth image allows at least one of the method of predicting the depth image by splitting the blocks forming the depth image into at least two partitions using the wedgelet as the boundary and the method of predicting the depth image by using the intra SDC mode, and when the first flag has a value of 0, determining that the depth image does not allow the method of predicting the depth image by splitting the blocks forming the depth image into at least two partitions using the wedgelet as the boundary and the method of predicting the depth image by using the intra SDC mode; when the second flag has a value of 1, determining that the depth image allows the method of predicting the depth image by splitting the blocks forming the depth image into at least two partitions using the contour as the boundary, and when the second flag has a value of 0, determining that the depth image does not allow the method of predicting the depth image by splitting the blocks forming the depth image into at least two partitions using the contour as the boundary; and when the third flag has a value of 1, determining that the depth image allows the method of predicting the depth image by using the inter SDC mode, and when the third flag has a value of 0, determining that the depth image does not allow the method of predicting the depth image by using the inter SDC mode.

The obtaining of the prediction mode information may include, when at least one of the first and second flags has a value of 1, obtaining a fourth flag indicating whether a method of predicting the depth image by splitting the current block into at least two partitions according to a pattern is allowed.

The obtaining of the prediction mode information may include, when it is determined that the method of predicting the depth image by splitting the current block into at least two partitions is allowed based on the obtained fourth flag, obtaining a fifth flag including information about a type of a method of splitting the current block, and wherein the fifth flag may specify one of a method of splitting the current block by using a wedgelet and a method of splitting the current block by using a contour.

The obtaining of the prediction mode information may include, when it is determined that the method of predicting the depth image by splitting the current block into at least two partitions is allowed based on the obtained fourth flag, specifying a type of a method of splitting the current block as one of a method of splitting the current block by using a wedgelet and a method of splitting the current block by using a contour, based on the obtained first and second flags.

The obtaining of the prediction mode information may include: determining whether the depth image allows using of an SDC mode; and when it is determined that the depth image allows the SDC mode, obtaining a sixth flag indicating whether an SDC mode of the current block is allowed.

The determining of whether the depth image allows the SDC mode may include: when a prediction mode of the current block is an inter mode, a partition mode of the current block is 2N×2N, and the third flag has a value of 1, determining that the depth image allows the using of the SDC mode; when the prediction mode of the current block is an intra mode, the partition mode of the current block is 2N×2N, and the first flag has a value of 1, determining that the depth image allows the using of the SDC mode; and when the prediction mode of the current block is a skip mode, determining that the depth image does not allow the using of the SDC mode.

The obtaining of the fourth flag may include decoding the fourth flag by using one independent context model for performing context-based adaptive binary arithmetic code (CABAC) decoding on the fourth flag.

The obtaining of the sixth flag may include decoding the sixth flag by using one independent context model for performing context-based adaptive binary arithmetic code (CABAC) decoding on the sixth flag.

According to an aspect of an embodiment, an inter-layer video encoding method includes: determining a prediction mode of a depth image; generating a prediction block of a current block forming the depth image by using the determined prediction mode; and encoding the depth image by using the prediction block, wherein the determining of the prediction mode includes generating a first flag, which indicates whether the depth flag allows a method of predicting the depth image by splitting blocks forming the depth image into at least two partitions using a wedgelet as a boundary, and a second flag, which indicates whether the depth image allows a method of predicting the depth image by splitting the blocks forming the depth image into at least two partitions using a contour as a boundary.

According to an aspect of an embodiment, an inter-layer video decoding apparatus includes: a prediction mode determiner configured to obtain prediction mode information of a depth image; a prediction block generator configured to generate a prediction block of a current block forming the depth image based on the obtained prediction mode information; and a decoder configured to decode the depth image by using the prediction block, wherein the prediction mode determiner obtains a first flag, which indicates whether the depth image allows a method of predicting the depth image by splitting blocks forming the depth image into at least two partitions using a wedgelet as a boundary, and a second flag, which indicates whether the depth image allows a method of predicting the depth image by splitting the blocks forming the depth image into at least two partitions using a contour as a boundary.

According to an aspect of an embodiment, an inter-layer video encoding apparatus includes: a prediction mode determiner configured to determine a prediction mode of a depth image; a prediction block generator configured to generate a prediction block of a current block forming the depth image by using the determined prediction mode; and an encoder configured to encode the depth image by using the prediction block, wherein the prediction mode determiner generates a first flag, which indicates whether the depth image allows a method of predicting the depth image by splitting blocks forming the depth image into at least two partitions using a wedgelet as a boundary, and a second flag, which indicates whether the depth image allows a method of predicting the depth image by splitting the blocks forming the depth image into at least two partitions using a contour as a boundary.

According to an aspect of an embodiment, a non-transitory computer-readable recording medium has recorded thereon a program, which when executed by a computer, performs the method.

### Mode of the Invention

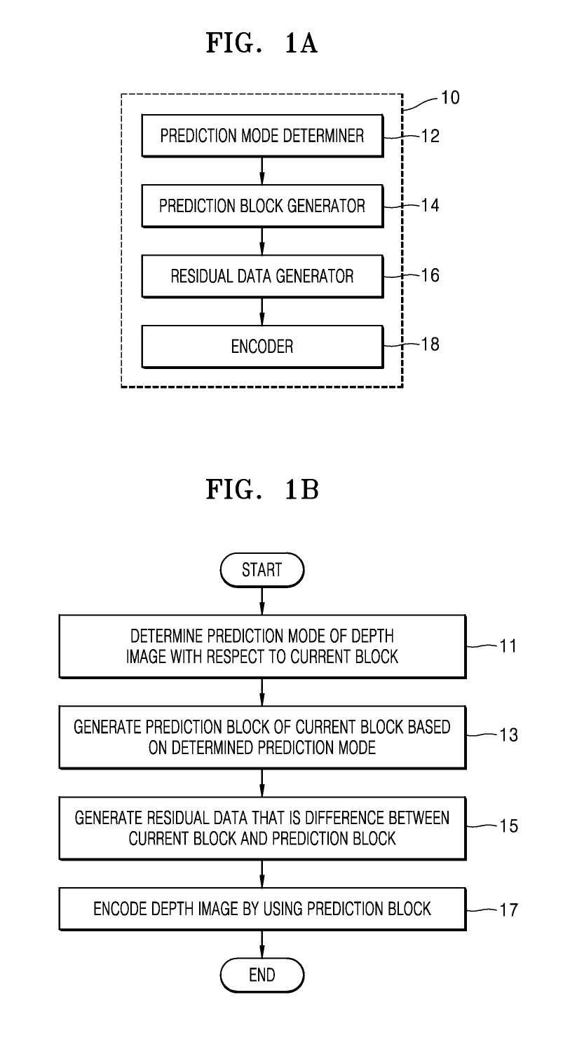

Hereinafter, a prediction method of a depth image for inter-layer video decoding and encoding apparatuses and methods, according to an embodiment, is suggested with reference to FIGS. 1A through 6.

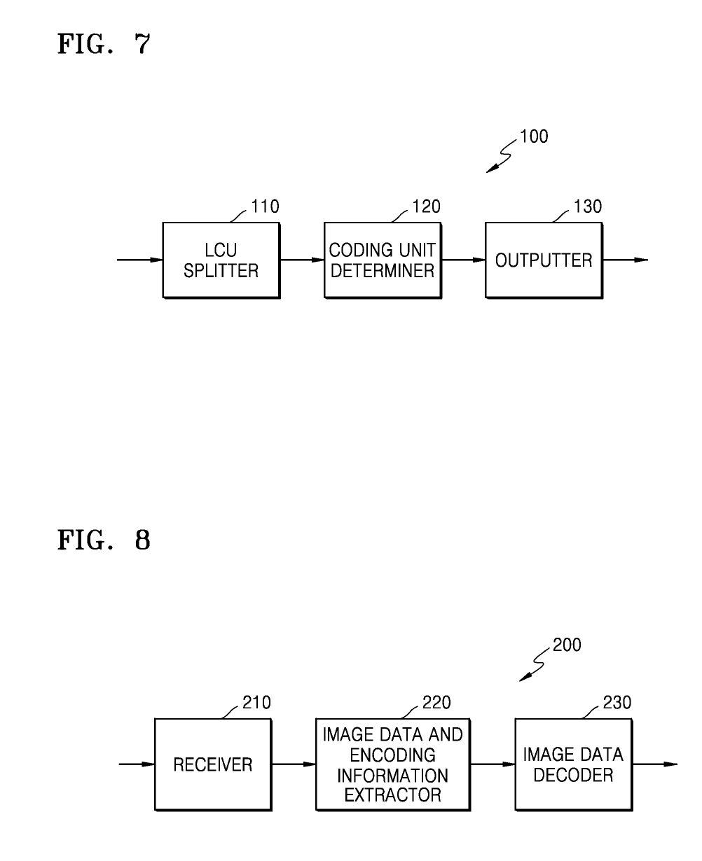

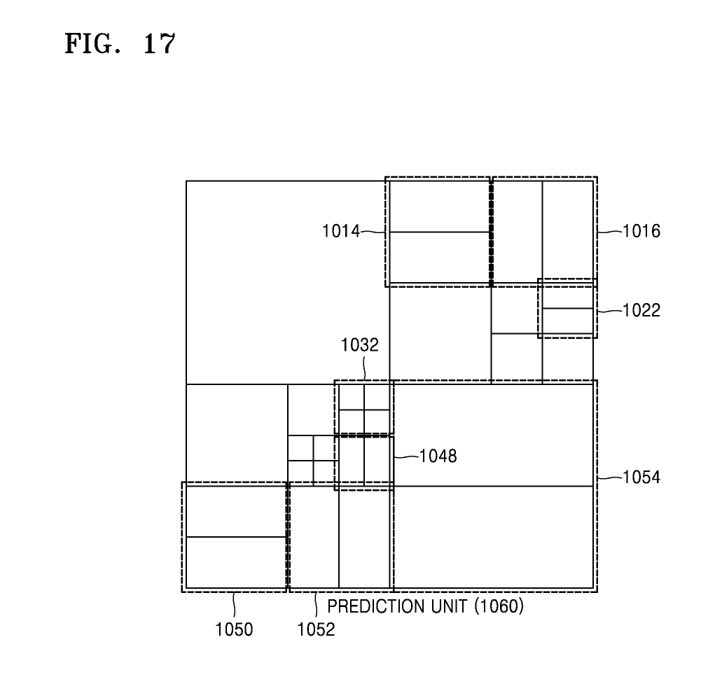

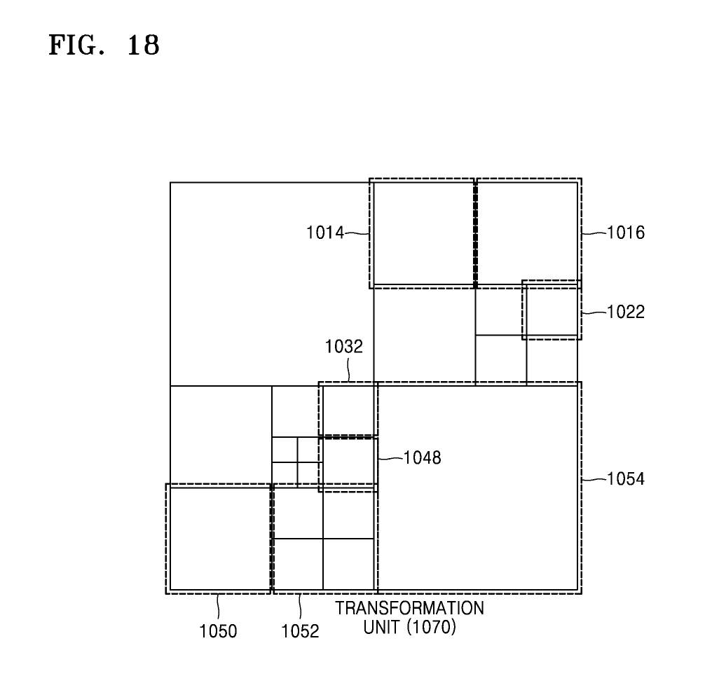

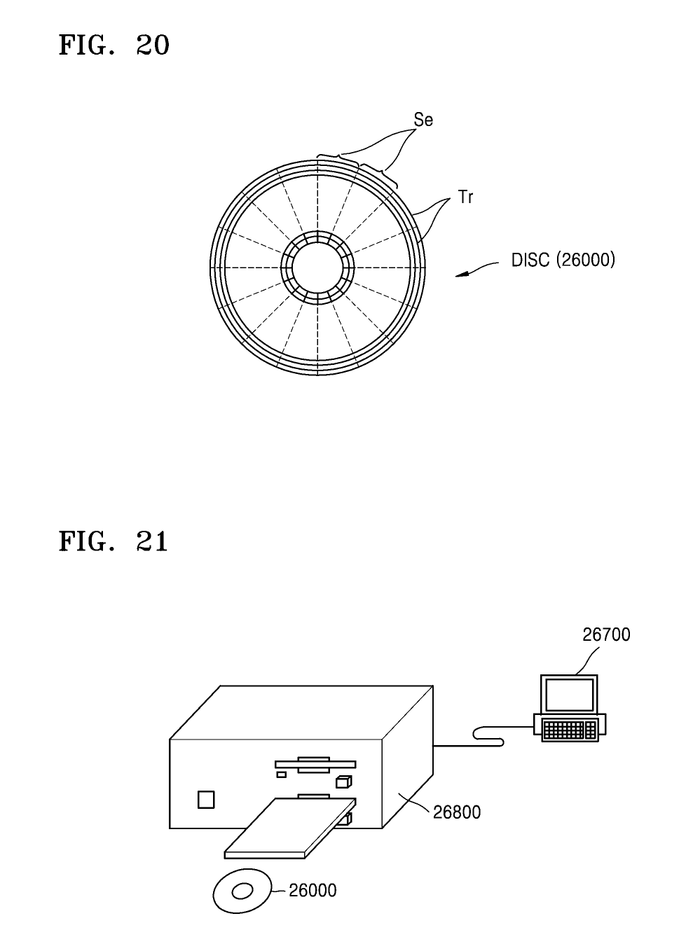

Also, a video encoding method and a video decoding method based on coding units having a tree structure, according to an embodiment, which are applicable to the inter-layer video encoding and decoding methods will be described with reference to FIGS. 7 through 19. In addition, various embodiments to which the video encoding method and the video decoding method are applicable will be described with reference to FIGS. 20 through 26.

Hereinafter, an ‘image’ may denote a still image or a moving image of a video, or a video itself.

Hereinafter, a ‘sample’ that is data allocated to a sampling location of an image may mean data that is a processing target. For example, pixels in an image of a spatial area may be samples.

Hereinafter, a ‘current block’ may denote a unit block of a depth image to be encoded or decoded.

First, a prediction method of a depth image and a transmission method of a prediction mode for inter-layer video decoding and encoding apparatuses and methods, according to an embodiment, will be described with reference to FIGS. 1A through 6.

FIG. 1A is a block diagram of an inter-layer video encoding apparatus 10 according to an embodiment. FIG. 1B is a flowchart of a video encoding method according to an embodiment.

The inter-layer video encoding apparatus 10 according to an embodiment may include a prediction mode determiner 12, a prediction block generator 14, a residual data generator 16, and an encoder 18. Also, the inter-layer video encoding apparatus 10 according to an embodiment may include a central processor (not shown) generally controlling the prediction mode determiner 12, the prediction block generator 14, the residual data generator 16, and the encoder 18. Alternatively, the prediction mode determiner 12, the prediction block generator 14, the residual data generator 16, and the encoder 18 may operate by their respective processors (not shown), and the inter-layer video encoding apparatus 10 may generally operate according to interactions of the processors (not shown). Alternatively, the prediction mode determiner 12, the prediction block generator 14, the residual data generator 16, and the encoder 18 may be controlled under control of an external processor (not shown) of the inter-layer video encoding apparatus 10.

The inter-layer video encoding apparatus 10 may include one or more data storage units (not shown) in which input and output data of the prediction mode determiner 12, the prediction block generator 14, the residual data generator 16, and the encoder 18 is stored. The inter-layer video encoding apparatus 10 may include a memory control unit (not shown) that controls data input and output of the data storage units (not shown).

The inter-layer video encoding apparatus 10 may operate in connection with an internal video encoding processor or an external video encoding processor so as to output video encoding results, thereby performing a video encoding operation including transformation. The internal video encoding processor of the inter-layer video encoding apparatus 10 may perform a video encoding operation as a separate processor. Also, the inter-layer video encoding apparatus 10, a central processing apparatus, or a graphic processing apparatus may include a video encoding processing module to perform a basic video encoding operation.

The inter-layer video encoding apparatus 10 according to an embodiment may classify and encode a plurality of image sequences for each layer according to scalable video coding and may output a separate stream including data encoded for each layer. The inter-layer video encoding apparatus 10 may encode first layer image sequences and second layer image sequences according to different layers.

For example, according to scalable video coding based on spatial scalability, low resolution images may be encoded as first layer images, and high resolution images may be encoded as second layer images. An encoding result of the first layer images may be output in a first layer stream. An encoding result of the second layer images may be output in a second layer stream.

As another example, a multi-view video may be encoded according to scalable video coding. In this case, center view images may be encoded as first layer images, and left view images and right view images may be encoded as second layer images that refer to the first layer images. Alternatively, when the inter-layer video encoding apparatus 10 permits three or more layers such as first, second, and third layers, the center view images may be encoded as the first layer images, the left view images may be encoded as the second layer images, and the right view images may be encoded as third layer images. However, the present invention is not necessarily limited thereto. Layers that the center view images, the left view images, and the right view images are encoded and referred may be changed.

As another example, scalable video coding may be performed according to temporal hierarchical prediction based on temporal scalability. A first layer stream including encoding information generated by encoding images of a base frame rate may be output. Temporal levels may be classified for each frame rate and may be respectively encoded in layers. A second layer stream including encoding information of a high speed frame rate may be output by further encoding images of the high frame rate with reference to the images of the basic frame rate.

Scalable video coding may be performed on a first layer and a plurality of second layers. In the presence of three or more second layers, first layer images, first second layer images, second second layers images, . . . , Kth second layer images may be encoded. Accordingly, an encoding result of the first layer images may be output in the first layer stream, and encoding results of the first second layer images, second second layers images, . . . , Kth second layer images may be respectively output in first, second, . . . Kth second layer streams.

The inter-layer video encoding apparatus 10 according to an embodiment may perform inter prediction for predicting a current image by referring to images of a single layer. A motion vector indicating motion information between the current image and a reference image and a residual between the current image and the reference image may be generated through inter prediction.

The inter-layer video encoding apparatus 10 may perform inter-layer prediction for predicting prediction information of second layer images by referring to prediction information of the first layer images.

When the inter-layer video encoding apparatus 10 according to an embodiment permits three or more layers such as a first layer, a second layer, a third layer, etc., the inter-layer video encoding apparatus 10 may perform inter-layer prediction between a first layer image and a third layer image and inter-layer prediction between a second layer image and the third layer image according to a multi-layer prediction structure.

A position differential component between the current image and a reference image of a different layer and a residual between the current image and the reference image of the different layer may be generated through inter-layer prediction.

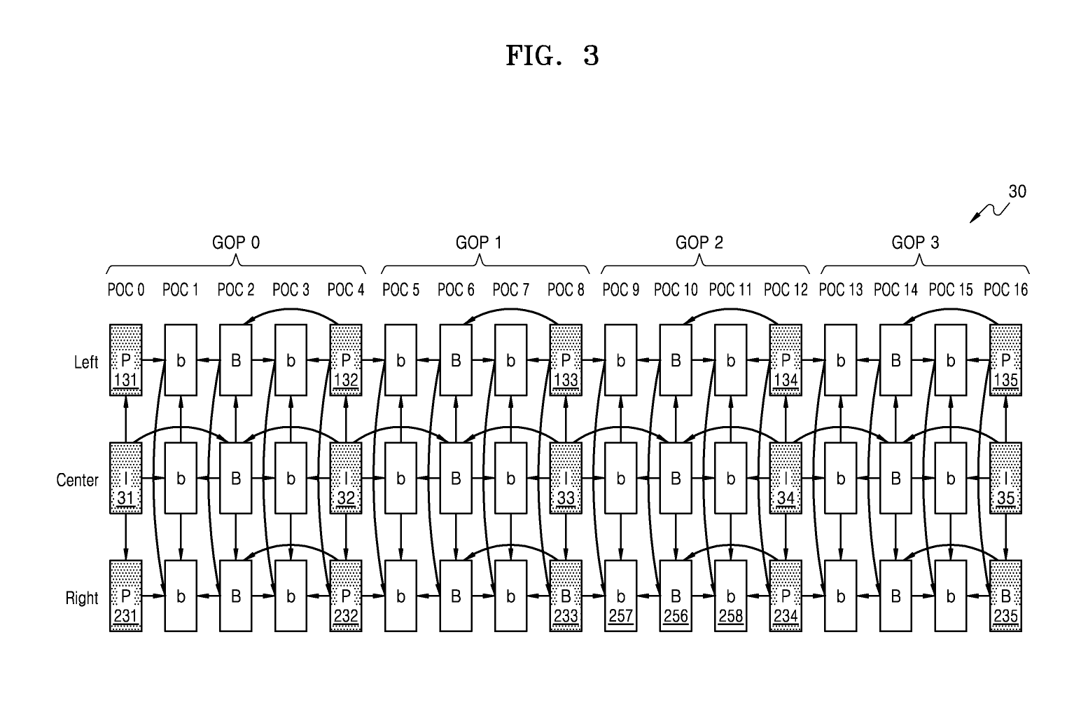

An inter-layer prediction structure will be described in detail with reference to FIG. 3 later.

The inter-layer video encoding apparatus 10 according to an embodiment encodes each video image for each respective block according to each layer. A block may have a square shape, a rectangular shape, or any geometric shape and is not limited to a data unit having a predetermined size. A block may be a maximum coding unit, a coding unit, a prediction unit, a transformation unit, or the like from among coding units according to a tree structure. The maximum encoding unit including coding units having the tree structure is diversely referred to as a coding tree unit, a coding block unit, a block tree, a root block tree, a coding tree, a coding root or a tree trunk. Video encoding and decoding methods based on coding units having the tree structure will now be described with reference to FIGS. 7 through 19.

Meanwhile, when the inter-layer video encoding apparatus 10 according to an embodiment encodes a multi-view video image, the inter-layer video encoding apparatus 10 may additionally encode auxiliary data, such as a depth image, and thus may generate images corresponding to more views than views input through a decoder. Here, since the depth image is used to compose an image of an intermediate view rather than directly shown to a user, deterioration of the depth image may affect the quality of a composite image.

A variation of a depth value of the depth image is large near a boundary of an object and is relatively small inside the object or in a background region. Thus, an error of the composite image may be reduced by reducing an error generated in a boundary region of an object in which a difference between depth values is high. Also, encoding efficiency of the depth image may be increased by reducing a data amount with respect to the inside of the object or in the background region in which the variation of the depth value is small.

Accordingly, the inter-layer video encoding apparatus 10 may encode a current block in the depth image by using intra prediction mode, such as a DC mode, a planar mode, or an angular mode. Also, the inter-layer video encoding apparatus 10 may encode the depth image by using a prediction mode, such as a depth modeling mode (DMM), a simplified depth coding (SDC) mode, or a CCD. The inter-layer video encoding apparatus 10 may generate a flag including information about whether the above prediction mode is used, according to layers.

The inter-layer video encoding apparatus 10 may generate a prediction block based on a predetermined prediction mode, and generate differential data, i.e., residual data, between the generated prediction block and the current block to be encoded.

The residual data generated by using the predetermined prediction mode may not be entirely encoded or may be partially encoded. The inter-layer video encoding apparatus 10 according to an embodiment may encode an average value of the residual data.

Meanwhile, the inter-layer video encoding apparatus 10 according to an embodiment may calculate a DC value (hereinafter, an average value) with respect to a block to be encoded, and determine an index by mapping the calculated average value to a depth lookup table. Here, the depth lookup table is a table in which a depth value available to the depth image and an index are matched to each other.

Also, the inter-layer video encoding apparatus 10 may only transmit, to a decoding apparatus, a difference value between an index determined by mapping an average value of an original block to the depth lookup table and an index calculated through an average value obtained from a prediction block. In this case, the difference value between the indexes may be encoded.

Hereinafter, operations of the inter-layer video encoding apparatus 10 according to an embodiment will be described in detail with reference to FIG. 1 B.

In operation 11, the prediction mode determiner 12 may determine a prediction mode of a depth image and a current block. Examples of the prediction mode may include a DC mode, a planar mode, an angular mode, a DMM, and an SDC mode.

Here, the DC mode is an intra prediction mode using a method of filling prediction samples of a prediction block with an average value of adjacent reference samples of the current block.

Also, the planar mode is an intra prediction mode in which a prediction sample predSample[x],[y] with respect to a reference sample is calculated according to Equation 1 below, wherein x and y are each an integer from 0 to nTbS −1.

predSamples[x][y]=((nTBS −1−x)*p[−1][y]+(x+1)*p[nTbS][−1]+(nTbS −1−y)*p[x][−1]+(y+1)*p[−1][nTbS]+nTbS)>>(Log2(nTbS)+1). [Equation 1]

Here, nTbS denotes a width or height of a prediction block.

Also, the angular mode is a prediction mode determining a prediction sample from reference samples in consideration of directivity from mode 2 to mode 34 from among prediction modes in a screen.

Also, a DMM prediction mode is DMM technology and is a method for efficiently and accurately representing an object boundary of a depth image. In detail, the DMM prediction mode is a mode of performing prediction by splitting a current block into at least two regions according to a pattern, and may calculate an average value according to regions obtained by using a wedgelet and a contour.

The DMM prediction mode may include a DMM mode-1 (also referred to as a DMM_WFULL mode or INTRA_DEP_WEDGE) and a DMM mode-4 (also referred to as a DMM_CPREDTEX mode or INTRA_DEP_CONTOUR). The DMM mode-1 is a wedgelet mode in which the inter-layer encoding apparatus 10 splits a current block into regions based on the most suitable boundary after trying splitting the current block into two regions by applying several boundaries. Here, a wedgelet denotes a diagonal line and a wedgelet partition denotes two or more partitions obtained by splitting a current prediction coding block by using a diagonal line as a boundary.

The DMM mode-4 is a mode in which a prediction block is split into at least two regions according to a pattern of texture of a current block, and a contour partition is found from a block of a corresponding color frame. Here, a contour denotes a curve including an arbitrary shape, and a contour partition denotes two or more partitions split from a current prediction coding block using a contour as a boundary.

An SDC prediction mode is a mode used when residual data is encoded in a DC format or is not encoded based on a fact that a variation of a depth value inside an object and in a background region is low. A DC component of the residual data is a pixel value of a residual block, and may be determined as an average value of all or some pixel values of the residual block.

The SDC prediction mode may include an SDC intra prediction mode and an SDC inter prediction mode. For example, the SDC intra prediction mode may include a DC prediction mode, a DMM mode-1 prediction mode, a DMM mode-4 prediction mode, and a planar prediction mode, and the inter-layer video encoding apparatus 10 may predict and encode a current block in a representative mode having highest possibility from among representative modes included in the SDC intra prediction mode. The SDC inter prediction mode may be configured by using a predetermined prediction mode, and may be configured differently depending on a partition mode. For example, the SDC inter prediction mode may be allowed only when a partition mode is 2N×2N, and may not be allowed when a partition mode is 2N×N, N×2N, N×N, or the like.

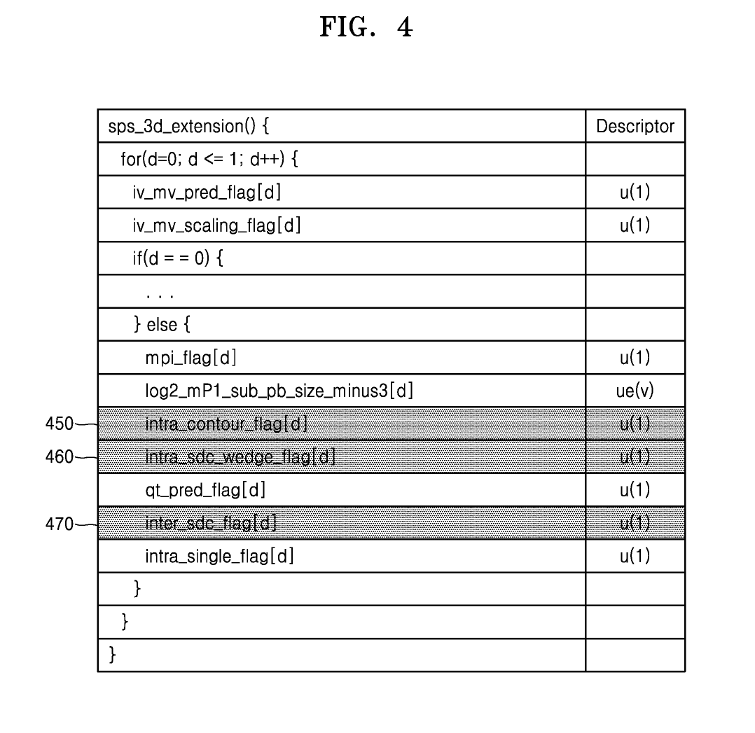

The prediction mode determiner 12 may generate a flag including information about a prediction mode used by a current depth image and a current block. The flag including the prediction mode information will be described later with reference to FIGS. 4 through 6.

In operation 13, the prediction block generator 14 may generate a prediction block of the current block based on the determined prediction mode.

In operation 15, the residual data generator 16 may generate residual data that is a difference between the current block and the prediction block. The residual data generator 16 according to an embodiment may not transmit the residual data to the encoder 18 or may average and transmit all or some of the residual data to the encoder 18.

For example, the residual data generator 16 may calculate an average value by using a left upper pixel value, a right upper pixel value, a left lower pixel value, and a right lower pixel value in a residual block that is a difference between the current block and the prediction block, and transmit the average value to the encoder 18. In detail, the residual data generator 16 may perform a weighted sum on a left upper pixel value, a right upper pixel value, a left lower pixel value, and a right lower pixel value of the prediction block rather than calculate an average value by using all pixel values in the residual block. However, an embodiment is not limited thereto, and an average value of the residual block may be predicted by using at least one pixel value (for example, four left upper pixel values and four right upper pixel values) according to pixel locations.

Also, the residual data generator 16 may differently obtain an average value of the residual block according to prediction modes. For example, when the prediction block is predicted in a DC or planar mode, the residual data generator 16 may calculate an average value of the residual block by using an average of the left upper pixel value, the right upper pixel value, the left lower pixel value, and the right lower pixel value, and transmit the average value of the residual block to the encoder 18.

Also, when the prediction block is predicted in a DMM, the residual data generator 16 may predict an average value according to regions by using the left upper pixel value, the right upper pixel value, the left lower pixel value, and the right lower pixel value of the prediction block according to regions split from the residual block.

As another example, the residual data generator 16 may predict an average value of the residual block by using a pixel value in different locations according to a prediction mode of the current block.

As another example, when the prediction block is predicted in a horizontal direction or vertical direction prediction mode from among angular modes, the residual data generator 16 may not transmit the residual data to the encoder 18.

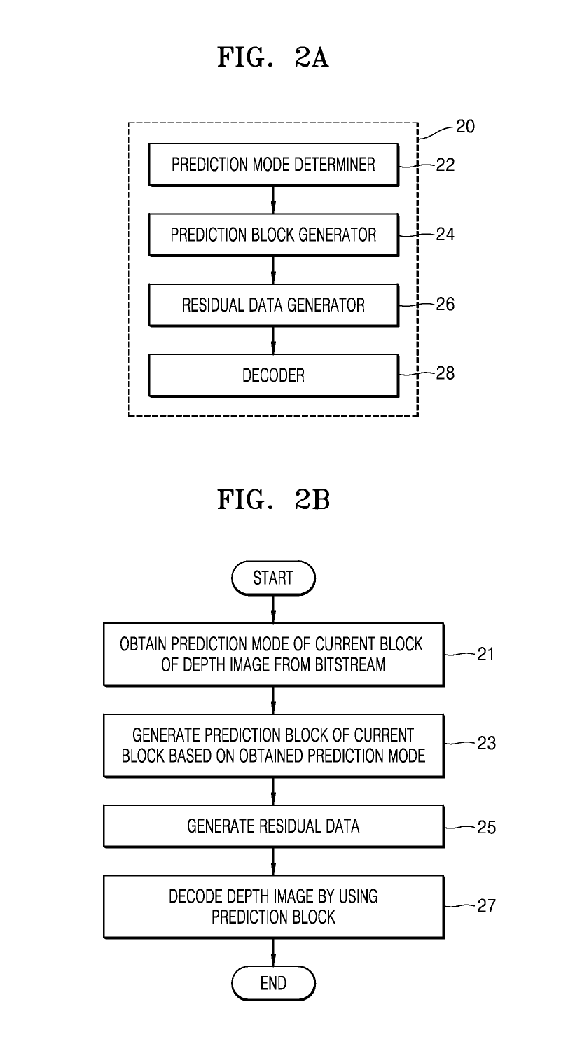

FIG. 2A is a block diagram of an inter-layer video decoding apparatus 20 according to an embodiment.

The inter-layer video decoding apparatus 20 according to an embodiment may include a parser 22, a prediction block generator 24, a residual data generator 26, and a decoder 28. Also, the inter-layer video decoding apparatus 20 according to an embodiment may include a central processor (not shown) generally controlling the parser 22, the prediction block generator 24, the residual data generator 26, and the decoder 28. Alternatively, the parser 22, the prediction block generator 24, the residual data generator 26, and the decoder 28 may operate by their respective processors (not shown), and the inter-layer video decoding apparatus 20 may generally operate according to interactions of the processors (not shown). Alternatively, the parser 22, the prediction block generator 24, the residual data generator 26, and the decoder 28 may be controlled under control of an external processor (not shown) of the inter-layer video decoding apparatus 20 according to an embodiment.

Also, the inter-layer video decoding apparatus 20 according to an embodiment may include one or more data storage units (not shown) in which input and output data of the parser 22, the prediction block generator 24, the residual data generator 26, and the decoder 28 is stored. The inter-layer video decoding apparatus 20 may include a memory control unit (not shown) that controls data input and output of the data storage units (not shown).

The inter-layer video decoding apparatus 20 according to an embodiment may operate in connection with an internal video decoding processor or an external video decoding processor so as to reconstruct a video through video decoding, thereby performing a video decoding operation including inverse transformation. The internal video decoding processor of the inter-layer video decoding apparatus 20 according to an embodiment may perform a basic video decoding operation as a separate processor, and in addition, the inter-layer video decoding apparatus 20, a central processing apparatus, or a graphic processing apparatus may include a video decoding processing module to perform the basic video decoding operation.

The inter-layer video decoding apparatus 20 according to an embodiment may receive bitstreams for each layer according to scalable encoding. The number of layers of the bitstreams received by the inter-layer video decoding apparatus 20 is not limited.

For example, the inter-layer video decoding apparatus 20 based on spatial scalability may receive streams in which image sequences of different resolutions are encoded according to different layers. A low resolution image sequence may be reconstructed by decoding the first layer stream, and a high resolution image sequence may be reconstructed by decoding the second layer stream.

As another example, a multi-view video may be decoded according to scalable video coding. When a stereoscopic video stream is received in multiple layers, the first layer stream may be decoded to reconstruct left view images. The second layer stream may be further decoded to the first layer stream to reconstruct right view images.

Alternatively, when a multi-view video stream is received in multiple layers, the first layer stream may be decoded to reconstruct center view images. The second layer stream may be further decoded to the first layer stream to reconstruct the left view images. A third layer stream may be further decoded to the first layer stream to reconstruct the right view images.

As another example, scalable video coding based on temporal scalability may be performed. The first layer stream may be decoded to reconstruct base frame rate images. The second layer stream may be further decoded to the first layer stream to reconstruct high speed frame rate images.

In the presence of three or more second layers, first layer images may be reconstructed from the first layer stream. If the second layer stream is further decoded by referring to the first layer reconstruction images, second layer images may be further reconstructed. If a Kth layer stream is further decoded by referring to the second layer reconstruction images, Kth layer images may be further reconstructed.

The inter-layer video decoding apparatus 20 may obtain encoded data of the first layer images and second layer images from the first layer stream and the second layer stream and may further obtain a motion vector generated through inter prediction and prediction information generated through inter layer prediction.

For example, the inter-layer video decoding apparatus 20 may decode inter-predicted data for each layer and may decode inter layer-predicted data between a plurality of layers. Reconstruction may be performed through motion compensation and inter layer decoding based on a coding unit or a prediction unit.

Motion compensation for a current image is performed by referring to reconstruction images predicted through inter prediction of a same layer on each layer stream, and thus images may be reconstructed. Motion compensation means an operation of synthesizing a reference image determined by using a motion vector of the current image and a residual of the current image and reconfiguring a reconstruction image of the current image.

Also, the inter-layer video decoding apparatus 20 may perform inter-layer decoding with reference to prediction information of the first layer images so as to decode a second layer image predicted through inter-layer prediction. Inter-layer decoding means an operation of reconstructing prediction information of the current image by using prediction information of a reference block of a different layer so as to determine the prediction information of the current image.

The inter-layer video decoding apparatus 20 according to an embodiment may perform inter-layer decoding for reconstructing the third layer images predicted with reference to the second layer images. An inter layer prediction structure will be described in detail with reference to FIG. 3 later.

The inter-layer video decoding apparatus 20 decodes each image of a video for each block. A block may include a largest coding unit, a coding unit, a prediction unit, a transformation unit, etc. among coding units according to a tree structure. Video encoding and decoding methods based on the coding units according to a tree structure will be described later with reference to FIGS. 8 through 20.

Meanwhile, when the inter-layer video decoding apparatus 20 according to an embodiment reconstructs a multi-view video image, the inter-layer video decoding apparatus 20 may additionally decode auxiliary data, such as a depth image, and thus may generate images corresponding to more views than views input through a decoder. Here, since the depth image is used to compose an image of an intermediate view rather than directly shown to a user, deterioration of the depth image may affect the quality of a composite image.

A variation of a depth value of the depth image is large near a boundary of an object and is relatively small inside the object. Thus, an error of the composite image may be reduced by reducing an error generated in a boundary region of an object in which a difference between depth values is high. Also, decoding efficiency of the depth image may be increased by reducing a data amount with respect to the inside of the object in which the variation of the depth value is small.

Accordingly, the inter-layer video decoding apparatus 20 may decode the depth image by using a predetermined intra prediction mode, such as a DC mode, a planar mode, or an angular mode. Also, the inter-.layer video decoding apparatus 20 may decode the depth image by using a prediction mode, such as a DMM, an SDC mode, or a CCD) The DC mode, the planar mode, the angular mode, the DMM, and the SDC mode have been described above with reference to FIG. 1.

The inter-layer video decoding apparatus 20 may obtain a flag including information about a prediction mode used according to depth images and current blocks (i.e., encoding and decoding units). The inter-layer video decoding apparatus 20 according to an embodiment may receive a flag including prediction mode information from a video parameter set network abstraction layer (VPS NAL) unit including parameter information commonly used to decode base layer and enhancement layer encoding data. The inter-layer video decoding apparatus 20 according to another embodiment may receive a flag including prediction mode information from a sequence parameter set (SPS) NAL unit or a picture parameter set (PPS) NAL unit.

A PPS is a parameter set of at least one picture. For example, the PPS is a parameter set including parameter information commonly used to encode image encoding data of at least one picture. A PPS NAL unit is an NAL unit including a PPS. An SPS is a parameter set of a sequence. A sequence is a group of at least one picture. For example, the SPS may include parameter information commonly used to encode encoding data of pictures performing encoding by referring to at least one PPS.

The inter-layer video decoding apparatus 20 may generate a prediction block of a current block by using an intra prediction mode, such as a DC mode, a planar mode, or an angular mode, so as to decode a depth image. Also, the inter-layer video decoding apparatus 20 may generate the prediction block of the current block by using a DMM, an SDC mode, or a CCD. Also, the inter-layer video decoding apparatus 20 may receive, from a bitstream, differential data between the generated prediction block and a current block to be decoded, i.e., residual data.

Alternatively, the inter-layer video decoding apparatus 20 according to an embodiment may calculate a DC value (hereinafter, referred to as an average value) with respect to a prediction block, and calculate an index by mapping the calculated average value to a depth lookup table. Also, the inter-layer video decoding apparatus 20 may receive, through a bitstream, an index difference value between a reconstruction index corresponding to an average value of a reconstruction block and a prediction index corresponding to an average value of a prediction block.

Hereinafter, operations of the inter-layer video decoding apparatus 20 according to an embodiment will be described in detail with reference to FIG. 2B.

In operation 21, the parser 22 may obtain prediction mode information of a depth image and a current image, from a bitstream. The prediction mode information is information used to reconstruct the depth image and the current block, and may include information about whether a DC mode, a planar mode, an angular mode, a DMM, or an SDC mode is used.

In operation 21, the parser 22 may parse a flag including the prediction mode information. The flag including the prediction mode information will be described in detail later with reference to FIGS. 4 through 6.

In operation 23, the prediction block generator 24 may generate a prediction block of the current block based on the obtained prediction mode information.

In operation 25, the residual data generator 26 may obtain residual data from the bitstream. However, when a prediction mode is generated in a predetermined prediction mode, the residual data may not be decoded.

In operation 27, the decoder 28 may decode the depth image by using the prediction block.

Hereinafter, an inter-layer prediction structure usable by the inter-layer video encoding apparatus 10 according to an embodiment will be described with reference to FIG. 3.

FIG. 3 illustrates an inter-layer prediction structure according to an embodiment.

The inter-layer video encoding apparatus 10 according to an embodiment may prediction encode base view images, left view images, and right view images according to a reproduction order 30 of a multi-view video prediction structure shown in FIG. 3.

According to the reproduction order 30 of the multi-view video prediction structure of the related art, images of the same view may be arranged in a horizontal direction. Thus, left view images “Left” may be arranged in a line in the horizontal direction, base view images “Center” may be arranged in a line in the horizontal direction, and right view images “Right” may be arranged in a line in the horizontal direction. The base view images may be center view images, compared to the left and right view images.

Images having the same POC order may be arranged in a vertical direction. A POC of images is a reproduction order of images constituting video. “POC X” in the reproduction order 40 of the multi-view video prediction structure indicates a relative reproduction order of images positioned in a corresponding column. The smaller the number of X, the earlier the reproduction order, and the greater the number of X, the later the reproduction order.

Therefore, according to the reproduction order 30 of the multi-view video prediction structure of the related art, the left view images “Left” may be arranged in the horizontal direction according to the POC (reproduction order), the base view images “Center” may be in the horizontal direction according to the POC (reproduction order), and the right view images “Right” may be arranged in the horizontal direction according to the POC (reproduction order). The left and right view images positioned in the same column as that of the base view images have different views but have the same POC (reproduction order).

Four consecutive images of view images constitute a single GOP. Each GOP includes images between consecutive anchor pictures and a single key picture.

An anchor picture is a random access point. In this regard, when a predetermined reproduction position is selected from images that are arranged according to a reproduction order of video, that is, according to a POC, an anchor picture of which a POC is closest to the reproduction position is reproduced. The base view images include base view anchor pictures 31, 32, 33, 34, and 35, the left view images include left view anchor pictures 131, 132, 133, 134, and 135, and the right view images include right view anchor pictures 231, 232, 233, 234, and 235.

Multi-view images may be reproduced and predicted (restored) according to a GOP order. According to the reproduction order 30 of the multi-view video prediction structure, images included in a GOP 0 are reproduced according to views and then images included in a GOP 1 may be reproduced. That is, images included in each GOP may be reproduced in the order of GOP 0, GOP 1, GOP 2, and GOP 3. According to a coding order of the multi-view video prediction structure, the images included in the GOP 0 are predicted (restored) according to views and then the images included in the GOP 1 may be predicted (restored). That is, the images included in each GOP may be reproduced in the order of GOP 0, GOP 1, GOP 2, and GOP 3.

According to the reproduction order 30 of the multi-view video prediction structure, both inter-view prediction (inter-layer prediction) and inter prediction may be performed on images. In the multi-view video prediction structure, an image from which an arrow starts is a reference image, and an image to which an arrow is directed is an image that is predicted by using the reference image.

A predicting result of the base view images may be encoded and then may be output as a base view image stream, and a prediction result of the additional view images may be encoded and then may be output as a layer bitstream. In addition, a predicting result of the left view images may be output in a first layer bitstream and a predicting result of the right view images may be output in a second layer bitstream.

Only inter prediction is performed on base view images. That is, the anchor pictures 31, 32, 33, 34, and 35 that are I-picture type pictures do not refer to different images, whereas the remaining images that are B-picture type images and b-picture type images are predicted with reference to different base view images. The B-picture type images are predicted with reference to an I-picture type anchor picture having a preceding POC order and an I-picture type anchor picture having a later POC order. b-picture type images are predicted with reference to an I-picture type anchor picture having a preceding POC order and a B-picture type image having a later POC order or a B-picture type image having a preceding POC order and an I-picture type anchor picture having a later POC order.

Inter-view prediction (inter-layer prediction) referring to different view images and inter prediction referring to the same view images are respectively performed on the left view images and the right view images.

Inter-view prediction (inter-layer prediction) may be performed on the left view anchor pictures 131, 132, 133, 134, and 135, respectively, with reference to the base view anchor pictures 31, 32, 33, 34, and 35 having the same POC order. Inter-view prediction may be performed on the right view anchor pictures 231, 232, 233, 234, and 235, respectively, with reference to the base view anchor pictures 31, 32, 33, 34, and 35 or the left view anchor pictures 131, 132, 133, 134, and 135 having the same POC order. Inter-view prediction (inter-layer prediction) referring to different view images having the same POC order may be performed on remaining merge images among the left view images and the right view images, other than the anchor pictures 131, 132, 133, 134, 135, 231, 232, 233, 234, and 235.

The remaining merge images among the left view images and the right view images, other than the anchor pictures 131, 132, 133, 134, 135, 231, 232, 233, 234, and 235, are predicted with reference to the same view images.

However, the left view images and the right view images may not be predicted with reference to an anchor picture having a previous reproduction order among additional view images of the same view. That is, for inter prediction of a current left view image, the left view images except for a left view anchor picture having a reproduction order previous to that of the current left view image may be referred to. Likewise, for inter prediction of a current right view image, the right view images except for a right view anchor picture having a reproduction order previous to that of the current right view image may be referred to.

For inter prediction of the current left view image, prediction may be performed by not referring to a left view image that belongs to a GOP previous to a current GPO to which the current left view belongs but by referring to a left view image that belongs to the current GOP and is to be reconstructed before the current left view image. The right view image is the same as described above.

The inter-layer video decoding apparatus 20 according to an embodiment may prediction encode base view images, left view images, and right view images according to the reproduction order 30 of a multi-view video prediction structure shown in FIG. 3.

The left view images may be reconstructed via inter-view disparity compensation referring to the base view images and inter motion compensation referring to the left view images. The right view images may be reconstructed via inter-view disparity compensation referring to the base view images and the left view images and inter motion compensation referring to the right view images. Reference images need to be firstly reconstructed for disparity compensation and motion compensation of the left view images and the right view images.

For inter motion compensation of the left view images, the left view images may be reconstructed via inter motion compensation referring to reconstructed left view reference images. For inter motion compensation of the right view images, the right view images may be reconstructed via inter motion compensation referring to reconstructed right view reference images.

For inter motion compensation of the current left view image, prediction may be performed by not referring to a left view image that belongs to a GOP previous to a current GPO to which the current left view belongs but by referring to a left view image that belongs to the current GOP and is to be reconstructed before the current left view image. The right view image is the same as described above.

Hereinafter, a method of receiving, by an inter-layer video decoding apparatus, prediction mode information to predict and reconstruct a depth image, according to an embodiment, will be described with reference to FIGS. 4 through 6.

FIG. 4 illustrates a part of sequence parameter set (SPS) 3-dimensional (3D) expansion syntax according to an embodiment.

The inter-layer video decoding apparatus 20 according to an embodiment may receive a flag indicating whether a depth image allows inter SDC from among SDC modes. Also, the inter-layer video decoding apparatus 20 may receive a flag indicating whether a depth image allows DMM mode-4 (DMM_CPREDTEX) from among DMM modes. Also, the inter-layer video decoding apparatus 20 may receive a flag indicating whether a depth image allows a DMM mode-1 (DMM_WFULL) mode or an intra SDC mode from among DMM modes.

A reference numeral 450 of FIG. 4 indicates a flag intra_contour_flag[d] indicating whether using of DMM mode-4 is allowed. When the intra_contour_flag[d] 450 has a value of 1, a current depth image may allow a prediction mode of DMM mode-4. Accordingly, the current depth image may generate a prediction block by using DMM mode-4 and be decoded. On the other hand, when the intra_contour_flag[d] 450 has a value of 0, the current depth image is unable to be decoded by using DMM mode-4. When the intra_contour_flag[d] 450 is not defined, a value of the intra_contour_flag[d] 450 may be estimated to be 0.

A reference numeral 460 of FIG. 4 indicates a flag intra_sdc_wedge_flag[d] indicating whether using of DMM mode-1 and using of an intra SDC mode are allowed from among DMM modes. When the intra_sdc_wedge_flag[d] 460 has a value of 1, a current depth image may allow at least one of the DMM mode-1 and the intra SDC mode. Accordingly, the current depth image may generate a prediction block by using at least one of the DMM mode-1 and the intra SDC mode, and be decoded. On the other hand, when the intra_sdc_wedge_flag[d] 460 has a value of 0, the current depth image is unable to be decoded by using the DMM mode-1 and the intra SDC mode. When the intra_sdc_wedge_flag[d] 460 is not defined, a value of the intra_sdc_wedge_flag[d] 460 may be estimated to be 0.

A reference numeral 470 of FIG. 4 indicates a flag inter_sdc_flag[d] indicating whether an inter SDC mode is allowed from among DMM modes. When the inter_sdc_flag[d] 470 has a value of 1, a current depth image may allow the inter SDC mode. Accordingly, the current depth image may generate a prediction block by using the inter SDC mode and be decoded. On the other hand, when the inter_sdc_flag[d] 470 has a value of 0, the current depth image is unable to be decoded by using the inter SDC mode. When the inter_sdc_flag[d] 470 is not defined, a value of inter_sdc_flag[d] may be estimated to be 0.

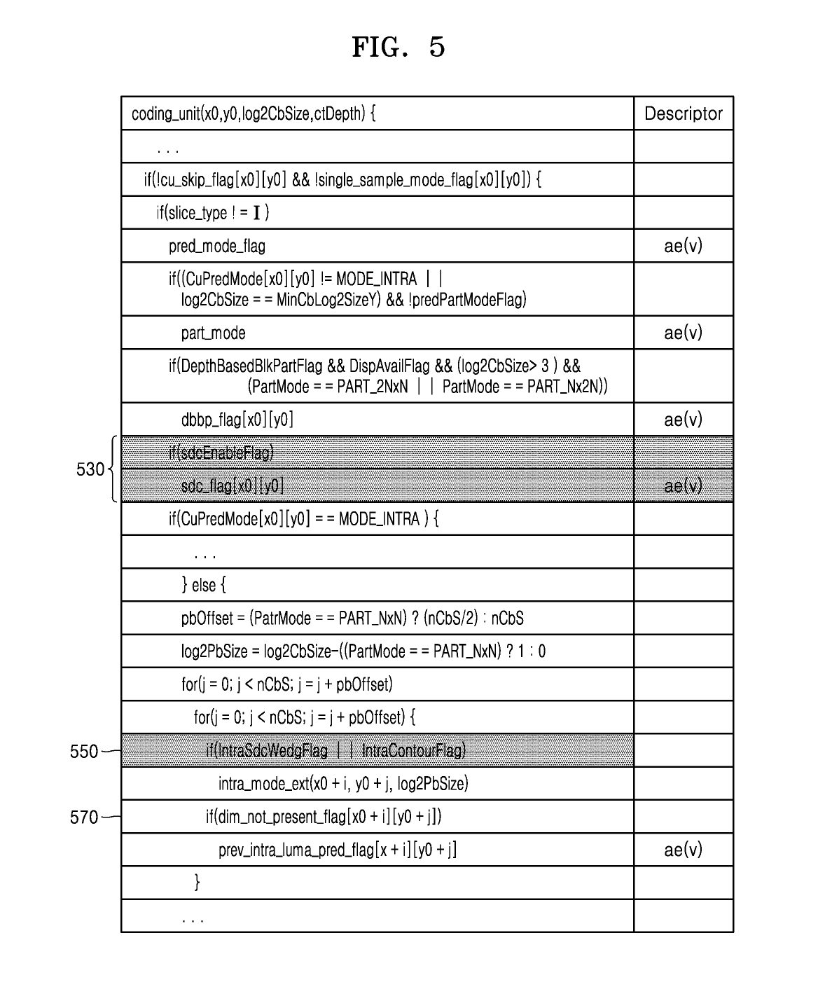

FIG. 5 illustrates a part of coding-unit syntax according to an embodiment.

A reference numeral 530 of FIG. 5 indicates a flag sdc_flag[x0][y0] indicating whether an SDC mode of a current block (i.e., a current coding unit) is allowed. The sdc_flag[x0][y0] indicates whether an SDC mode is applied to a coding unit located x0th from the left of a depth image and from y0th from the top of the depth image. When the sdc_flag[x0][y0] is 1, an SDC mode is applied to a coding unit corresponding to the sdc_flag[x0][y0]. On the other hand, when the sdc_flag[x0][y0] is 0, an SDC mode is not applied to the coding unit corresponding to the sdc_flag[x0][y0]. When the sdc_flag[x0][y0] is not defined, the sdc_flag[x0][y0] may be estimated to be 0.

A sdcEnableFlag is a condition for receiving a value of the sdc_flag[x0][y0]. In other words, the sdc_flag[x0][y0] may be received only when a value of the sdcEnableFlag is 1.

When a prediction mode of a current block is an inter prediction mode, the sdcEnableFlag has a value of 1 when a value of the inter_sdc_flag 470 is 1 and a partition mode of a coding unit is 2N×2N. When such conditions are not satisfied, the sdcEnableFlag has a value of 0.

When the prediction mode of the current block is an intra prediction mode, and when the intra_sdc_wedge_flag 460 is 1 and a partition mode of a coding unit is 2N×2N, the sdcEnableFlag has a value of 1. However, when such conditions are not satisfied, the sdcEnableFlag has a value of 0.

When the prediction mode of the current block is a skip mode, the sdcEnableFlag is 0.

A reference numeral 550 of FIG. 5 is a conditional statement for determining whether a DMM with respect to a current depth image is allowed to perform intra_mode_ext for obtaining a parameter of the DMM mode. In other words, when any one of the flag intra_contour_flag 450 and the flag intra_sdc_wedge_flag 460 has a value of 1, intra_mode_ext of obtaining a parameter for performing prediction by using a DMM on a current coding unit may be performed.

A reference numeral 570 of FIG. 5 indicates a flag dim_not_present_flag[x0 +i][y0 +j] indicating whether a DMM with respect to a current coding unit is allowed. When the dim_not_present_flag[x0 +i][y0 +j] 570 has a value of 1, a DMM is not allowed to a coding unit corresponding to the dim_not_present_flag[x0 +i][y0 +j], and when the dim_not_present_flag[x0 +i][y0 +j] 570 has a value of 0, a DMM is allowed to the coding unit corresponding to the dim_not_present_flag[x0 +i][y0 +j].

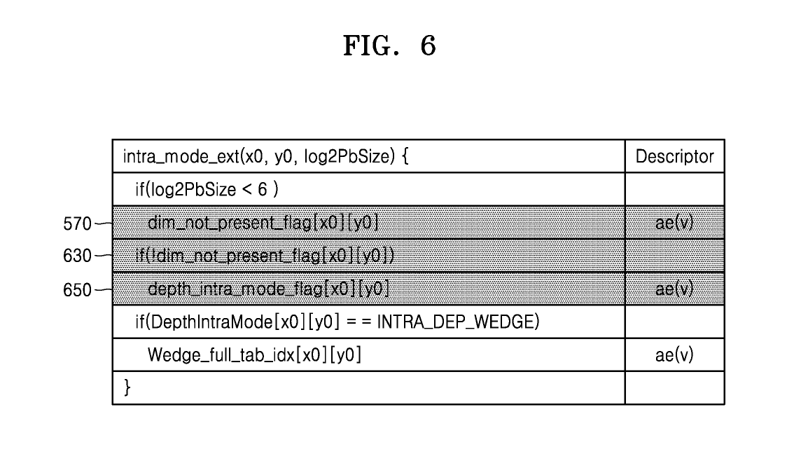

FIG. 6 illustrates intra-mode-ext syntax receiving a DMM parameter.

The inter-layer video decoding apparatus 20 may additionally receive a flag depth_intra_modeflag[x0][y0] 650 indicating a type of a DMM used in a current mode. In a conditional statement 630, when the dim_not_present_flag 570 is 0, the type of the DMM may be stored in the depth_intra_modeflag[x0][y0] 650. When a value of the depth_intra_modeflag[x0][y0] 650 is 0, DMM mode-1 may be indicated, and when the value is 1, DMM mode-4 may be indicated, but an embodiment is not limited thereto. As another example, when the dim_not_present_flag 570 is 0, the intra_contour_flag is 1, and the intra_sdc_wedge_{—flag is} 0, the depth_intra_modeflag[x0][y0] 650 may not be received and a type of the DMM may be determined to be DMM mode-4. When the dim_not_present_flag 570 is 0, the intra_contour_flag is 0, and the intra_sdc_wedge_flag is 1, the depth_intra_modeflag[x0][y0] 650 may not be received and a type of the DMM may be determined to be DMM mode-1.

The inter-layer video decoding apparatus 20 may receive, from the inter-layer video encoding apparatus 10, a bitstream including the sdc_flag 530 and the dim_not_present_flag 570 and encoded via context-based adaptive binary arithmetic coding (CABAC), and perform CABAC decoding on the received bitstream. Here, the flag sdc_flag 530 and the dim_not_present_flag 570 may be transmitted by using one independent context model without referring to adjacent block information.

Table 1 below includes information about which table will be used by the cu_extension syntax and the intra_mode_ext syntax described above with reference to FIGS. 5 and 6 to initialize the syntax elements sdc_flag 530 and dim_not_present_flag 570.

TABLE 1

| | | | initType | | |
|---|---|---|---|---|---|
| Syntax Structure | Syntax Element | ctxTable | 0 | 1 | 2 |
| cu_extension( ) | depth_intra_ | Table I.13 | 0 | 1 | 2 |
| intra_mode_ext( ) | mode_flag | | | | |
| | depth_dc_flag | Table I.14 | 0 | 1 | 2 |
| | depth_dc_abs | Table I.10 | 0 | 1 | 2 |
| | iv_res_pred_ | Table I.11 | | 0 . . . 2 | 3 . . . 5 |
| | weight_idx | | | | |
| | ic_flag | Table I.12 | | 0 | 1 |
| | dbbp_flag | Table I.15 | 0 | 1 | 2 |
| | sdc_flag | Table 2 | 0 | 1 | 2 |
| | dim_not_present_ | Table 3 | 0 | 1 | 2 |
| | flag | | | | |
| | single_sample_ | Table I.18 | 0 | 1 | 2 |
| | mode_flag | | | | |
| | single_sample_ | Table I.19 | 0 | 1 | 2 |
| | flag | | | | |

The sdc_flag 530 and the dim_not_present_flag 570 may be context-initialized by using context index information shown respectively in Table 2 and Table 3 below.

TABLE 2

| | ctxldx of sdc_flag_ctxldx | | |
|---|---|---|---|
| Initialization Variable | 0 | 1 | 2 |
| initValue | 154 | 154 | 154 |

TABLE 3

| | ctxldx of dim_not_present_flag ctxldx | | |
|---|---|---|---|
| Initialization variable | 0 | 1 | 2 |
| initValue | 154 | 141 | 155 |

Meanwhile, for convenience of description, only operations performed by the inter-layer video decoding apparatus 20 are described with reference to FIGS. 4 through 6, and operations performed by the inter-layer video encoding apparatus 10 are omitted, but it would be easily understood by one of ordinary skill in the art that corresponding operations would be performed by the inter-layer video encoding apparatus 10.

In the inter-layer video encoding apparatus 10 according to an embodiment and the inter-layer video decoding apparatus 20 according to an embodiment, as described above, video data may be split into coding units having a tree structure, and coding units, prediction units, and transformation units are used for inter-layer prediction or inter prediction on the coding units. Hereinafter, a video encoding method and apparatus and a video decoding method and apparatus based on coding units having a tree structure according to an embodiment will be described with reference to FIGS. 7 through 19.

FIG. 7 is a block diagram of the video encoding apparatus based on coding units according to a tree structure 100, according to an embodiment.

The video encoding apparatus involving video prediction based on coding units according to a tree structure 100 according to an embodiment includes a largest coding unit (LCU) splitter 110, a coding unit determiner 120, and an outputter 130. Hereinafter, for convenience of description, the video encoding apparatus involving video prediction based on coding units according to a tree structure 100 according to an embodiment is simply referred to as the ‘video encoding apparatus 100’.

The LCU splitter 110 may split a current picture based on a LCU that is a coding unit having a maximum size for a current picture of an image. If the current picture is larger than the LCU, image data of the current picture may be split into the at least one LCU. The LCU according to one or more embodiments may be a data unit having a size of 32×32, 64×64, 128×128, 256×256, etc., wherein a shape of the data unit is a square having a width and length in squares of 2. The image data may be output to the coding unit determiner 120 according to the at least one LCU.

A coding unit according to an embodiment may be characterized by a maximum size and a depth. The depth denotes the number of times the coding unit is spatially split from the LCU, and as the depth deepens, deeper coding units according to depths may be split from the LCU to a smallest coding unit (SCU). A depth of the LCU is an uppermost depth and a depth of the SCU is a lowermost depth. Since a size of a coding unit corresponding to each depth decreases as the depth of the LCU deepens, a coding unit corresponding to an upper depth may include a plurality of coding units corresponding to lower depths.

As described above, the image data of the current picture is split into the LCUs according to a maximum size of the coding unit, and each of the LCUs may include deeper coding units that are split according to depths. Since the LCU according to one or more embodiments is split according to depths, the image data of the space domain included in the LCU may be hierarchically classified according to depths.

A maximum depth and a maximum size of a coding unit, which limit the total number of times a height and a width of the LCU are hierarchically split, may be predetermined.

The coding unit determiner 120 encodes at least one split region obtained by splitting a region of the LCU according to depths, and determines a depth to output a finally encoded image data according to the at least one split region. In other words, the coding unit determiner 120 determines a coded depth by encoding the image data in the deeper coding units according to depths, according to the LCU of the current picture, and selecting a depth having the least encoding error. The determined coded depth and the encoded image data according to the determined depth are output to the outputter 130.

The image data in the LCU is encoded based on the deeper coding units corresponding to at least one depth equal to or below the maximum depth, and results of encoding the image data are compared based on each of the deeper coding units. A depth having the least encoding error may be selected after comparing encoding errors of the deeper coding units. At least one coded depth may be selected for each LCU.

The size of the LCU is split as a coding unit is hierarchically split according to depths, and as the number of coding units increases. Also, even if coding units correspond to the same depth in one LCU, it is determined whether to split each of the coding units corresponding to the same depth to a lower depth by measuring an encoding error of the image data of the each coding unit, separately. Accordingly, even when image data is included in one LCU, the encoding errors may differ according to regions in the one LCU, and thus the coded depths may differ according to regions in the image data. Thus, one or more coded depths may be determined in one LCU, and the image data of the LCU may be divided according to coding units of at least one coded depth.

Accordingly, the coding unit determiner 120 may determine coding units having a tree structure included in the LCU. The ‘coding units having a tree structure’ according to one or more embodiments include coding units corresponding to a depth determined to be the coded depth, from among all deeper coding units included in the LCU. A coding unit of a coded depth may be hierarchically determined according to depths in the same region of the LCU, and may be independently determined in different regions. Similarly, a coded depth in a current region may be independently determined from a coded depth in another region.

A maximum depth according to one or more embodiments is an index related to the number of splitting times from a LCU to an SCU. A first maximum depth according to one or more embodiments may denote the total number of splitting times from the LCU to the SCU. A second maximum depth according to one or more embodiments may denote the total number of depth levels from the LCU to the SCU. For example, when a depth of the LCU is 0, a depth of a coding unit, in which the LCU is split once, may be set to 1, and a depth of a coding unit, in which the LCU is split twice, may be set to 2. Here, if the SCU is a coding unit in which the LCU is split four times, 5 depth levels of depths 0, 1, 2, 3, and 4 exist, and thus the first maximum depth may be set to 4, and the second maximum depth may be set to 5.

Prediction encoding and transformation may be performed according to the LCU. The prediction encoding and the transformation are also performed based on the deeper coding units according to a depth equal to or depths less than the maximum depth, according to the LCU.

Since the number of deeper coding units increases whenever the LCU is split according to depths, encoding, including the prediction encoding and the transformation, is performed on all of the deeper coding units generated as the depth deepens. For convenience of description, the prediction encoding and the transformation will now be described based on a coding unit of a current depth, in a LCU.

The video encoding apparatus 100 according to an embodiment may variously select a size or shape of a data unit for encoding the image data. In order to encode the image data, operations, such as prediction encoding, transformation, and entropy encoding, are performed, and at this time, the same data unit may be used for all operations or different data units may be used for each operation.

For example, the video encoding apparatus 100 may select not only a coding unit for encoding the image data, but also a data unit different from the coding unit so as to perform the prediction encoding on the image data in the coding unit.

In order to perform prediction encoding in the LCU, the prediction encoding may be performed based on a coding unit corresponding to a coded depth, i.e., based on a coding unit that is no longer split to coding units corresponding to a lower depth. Hereinafter, the coding unit that is no longer split and becomes a basis unit for prediction encoding will now be referred to as a ‘prediction unit’. A partition obtained by splitting the prediction unit may include a prediction unit and a data unit obtained by splitting at least one of a height and a width of the prediction unit. A partition is a data unit where a prediction unit of a coding unit is split, and a prediction unit may be a partition having the same size as a coding unit.

For example, when a coding unit of 2N×2N (where N is a positive integer) is no longer split and becomes a prediction unit of 2N×2N, and a size of a partition may be 2N×2N, 2N×N, N×2N, or N×N. Examples of a partition type may selectively include symmetrical partitions that are obtained by symmetrically splitting a height or width of the prediction unit, partitions obtained by asymmetrically splitting the height or width of the prediction unit, such as 1:n or n:1, partitions that are obtained by geometrically splitting the prediction unit, or partitions having arbitrary shapes.

A prediction mode of the prediction unit may be at least one of an intra mode, a inter mode, and a skip mode. For example, the intra mode or the inter mode may be performed on the partition of 2N×2N, 2N×N, N×2N, or N×N. Also, the skip mode may be performed only on the partition of 2N×2N. The encoding is independently performed on one prediction unit in a coding unit, thereby selecting a prediction mode having a least encoding error.

Also, the video encoding apparatus 100 according to an embodiment may also perform the transformation on the image data in a coding unit based not only on the coding unit for encoding the image data, but also based on a data unit that is different from the coding unit. In order to perform the transformation in the coding unit, the transformation may be performed based on a data unit having a size smaller than or equal to the coding unit. For example, the data unit for the transformation may include a data unit for an intra mode and a data unit for an inter mode.

The transformation unit in the coding unit may be recursively split into smaller sized regions in the similar manner as the coding unit according to the tree structure. Thus, residues in the coding unit may be divided according to the transformation unit having the tree structure according to transformation depths.

A transformation depth indicating the number of splitting times to reach the transformation unit by splitting the height and width of the coding unit may also be set in the transformation unit. For example, in a current coding unit of 2N×2N, a transformation depth may be 0 when the size of a transformation unit is 2N×2N, may be 1 when the size of the transformation unit is N×N, and may be 2 when the size of the transformation unit is N/2×N/2. In other words, the transformation unit having the tree structure may be set according to the transformation depths.

Encoding information according to coded depths requires not only information about the coded depth, but also about information related to prediction encoding and transformation. Accordingly, the coding unit determiner 120 not only determines a coded depth having a least encoding error, but also determines a partition type in a prediction unit, a prediction mode according to prediction units, and a size of a transformation unit for transformation.

Coding units according to a tree structure in a LCU and methods of determining a prediction unit/partition, and a transformation unit, according to an embodiment, will be described in detail below with reference to FIGS. 7 through 19.

The coding unit determiner 120 may measure an encoding error of deeper coding units according to depths by using Rate-Distortion Optimization based on Lagrangian multipliers.

The outputter 130 outputs the image data of the LCU, which is encoded based on the at least one coded depth determined by the coding unit determiner 120, and information about the encoding mode according to the depth, in bitstreams.

The encoded image data may be obtained by encoding residues of an image.

The information about the encoding mode according to depths may include information about the coded depth, about the partition type in the prediction unit, the prediction mode, and the size of the transformation unit.

The information about the coded depth may be defined by using splitting information according to depths, which indicates whether encoding is performed on coding units of a lower depth instead of a current depth. If the current depth of the current coding unit is the coded depth, image data in the current coding unit is encoded and output, and thus the splitting information may be defined not to split the current coding unit to a lower depth. Alternatively, if the current depth of the current coding unit is not the coded depth, the encoding is performed on the coding unit of the lower depth, and thus the splitting information may be defined to split the current coding unit to obtain the coding units of the lower depth.

If the current depth is not the coded depth, encoding is performed on the coding unit that is split into the coding unit of the lower depth. Since at least one coding unit of the lower depth exists in one coding unit of the current depth, the encoding is repeatedly performed on each coding unit of the lower depth, and thus the encoding may be recursively performed for the coding units having the same depth.

Since the coding units having a tree structure are determined for one LCU, and information about at least one encoding mode is determined for a coding unit of a coded depth, information about at least one encoding mode may be determined for one LCU. Also, a coded depth of the image data of the LCU may be different according to locations since the image data is hierarchically split according to depths, and thus the coded depth and the information about the encoding mode may be set for the image data.

Accordingly, the outputter 130 may assign the coded depth and the encoding information about the encoding mode to at least one of the coding unit, the prediction unit, and a minimum unit included in the LCU.

The minimum unit according to one or more embodiments is a square data unit obtained by splitting the SCU constituting the lowermost coded depth by 4. Alternatively, the minimum unit according to an embodiment may be a maximum square data unit that may be included in all of the coding units, prediction units, partition units, and transformation units included in the LCU.

For example, the encoding information output by the outputter 130 may be classified into encoding information according to deeper coding units, and encoding information according to prediction units. The encoding information according to the deeper coding units may include the information about the prediction mode and about the size of the partitions. The encoding information according to the prediction units may include information about an estimated direction of an inter mode, about a reference image index of the inter mode, about a motion vector, about a chroma component of an intra mode, and about an interpolation method of the intra mode.

Information about a maximum size of the coding unit defined according to pictures, slices, or GOPs, and information about a maximum depth may be inserted into a header of a bitstream, a sequence parameter set, or a picture parameter set.

Information about a maximum size of the transformation unit permitted with respect to a current video, and information about a minimum size of the transformation unit may also be output through a header of a bitstream, a sequence parameter set, or a picture parameter set. The outputter 130 may encode and output reference information related to prediction, prediction information, single direction prediction information, and slice type information including a fourth slice type, which are described above with reference to FIGS. 1 through 6.

In the video encoding apparatus 100, the deeper coding unit may be a coding unit obtained by dividing a height or width of a coding unit of an upper depth, which is one layer above, by two. In other words, when the size of the coding unit of the current depth is 2N×2N, the size of the coding unit of the lower depth is N×N. Also, the coding unit with the current depth having a size of 2N×2N may include a maximum of 4 of the coding units with the lower depth.

Accordingly, the video encoding apparatus 100 may form the coding units having the tree structure by determining coding units having an optimum shape and an optimum size for each LCU, based on the size of the LCU and the maximum depth determined considering characteristics of the current picture. Also, since encoding may be performed on each LCU by using any one of various prediction modes and transformations, an optimum encoding mode may be determined considering characteristics of the coding unit of various image sizes.

Thus, if an image having a high resolution or a large data amount is encoded in a conventional macroblock, the number of macroblocks per picture excessively increases. Accordingly, the number of pieces of compressed information generated for each macroblock increases, and thus it is difficult to transmit the compressed information and data compression efficiency decreases. However, by using the video encoding apparatus 100, image compression efficiency may be increased since a coding unit is adjusted while considering characteristics of an image while increasing a maximum size of a coding unit while considering a size of the image.

The video encoding apparatus 100 of FIG. 7 may perform operations of the video encoding apparatus 10 described above with reference to FIG. 1.

The coding unit determiner 120 may perform operations of the intra predictor 12 of the video encoding apparatus 10. A prediction unit for intra prediction may be determined according to coding units according to a tree structure, per LCU, and then intra prediction may be performed according to prediction units.

The outputter 130 may perform operations of the symbol encoder 14 of the video encoding apparatus 10. For prediction of an intra prediction mode, an MPM flag may be encoded per prediction unit. When an intra prediction mode of a current prediction unit is the same as at least one of intra prediction modes of left/top prediction units, a fixed number of candidate intra prediction modes are determined regardless of whether a left intra prediction mode and a top intra prediction mode are the same, and current intra mode information for the current prediction unit may be determined and encoded based on the candidate intra prediction modes.

The outputter 130 may determine the number of candidate intra prediction modes per picture. Similarly, the number of candidate intra prediction modes may be determined per slice, per LCU, per coding unit, or per prediction unit. However, an embodiment is not limited thereto, and the number of candidate intra prediction modes may be determined again per predetermined data unit.

The outputter 130 may encode information indicating the number of candidate intra prediction modes as a parameter of various data unit levels, such as a picture parameter set (PPS), a slice parameter set (SPS), a LCU level, a coding unit level, and a prediction unit level, according to a level of a data unit in which the number of candidate intra prediction modes is updated. However, even when the number of candidate intra prediction modes is determined every time per predetermined data unit, the information indicating the number of candidate intra prediction modes is not always encoded.

FIG. 8 is a block diagram of a video decoding apparatus based on coding units having a tree structure 200, according to an embodiment.

The video decoding apparatus that involves video prediction based on coding units having a tree structure 200 according to an embodiment includes a receiver 210, an image data and encoding information extractor 220, and an image data decoder 230. Hereinafter, for convenience of description, the video decoding apparatus that involves video prediction based on coding units having a tree structure 200 according to an embodiment will be simply referred to as the ‘video decoding apparatus 200’.

Definitions of various terms, such as a coding unit, a depth, a prediction unit, a transformation unit, and information about various encoding modes, for decoding operations of the video decoding apparatus 200 are identical to those described with reference to FIG. 7 and the video encoding apparatus 100.

The receiver 210 receives and parses a bitstream of an encoded video. The image data and encoding information extractor 220 extracts encoded image data for each coding unit from the parsed bitstream, wherein the coding units have a tree structure according to each LCU, and outputs the extracted image data to the image data decoder 230. The image data and encoding information extractor 220 may extract information about a maximum size of a coding unit of a current picture, from a header about the current picture, a sequence parameter set, or a picture parameter set.

Also, the image data and encoding information extractor 220 extracts a coded depth and information about an encoding mode for the coding units having a tree structure according to each LCU, from the parsed bitstream. The extracted coded depth and the information about an encoding mode are output to the image data decoder 230. In other words, the image data in a bit stream is split into the LCU so that the image data decoder 230 decodes the image data for each LCU.

The coded depth and the information about an encoding mode according to the LCU may be set for at least one piece of coded depth information, and the information about an encoding mode according to the coded depth may include information about a partition type of a corresponding coding unit corresponding to the depth, information about a prediction mode, and size information of a transformation unit. Also, splitting information according to depths may be extracted as the coded depth information.

The coded depth and the information about an encoding mode according to each LCU extracted by the image data and encoding information extractor 220 is a coded depth and information about an encoding mode determined to generate a minimum encoding error when an encoder, such as the video encoding apparatus 100, repeatedly performs encoding for each deeper coding unit according to depths according to each LCU. Accordingly, the video decoding apparatus 200 may reconstruct an image by decoding the image data according to a depth and an encoding mode that generates the minimum encoding error.

Since the coded depth and the information about an encoding mode may be assigned to a predetermined data unit from among a corresponding coding unit, a prediction unit, and a minimum unit, the image data and encoding information extractor 220 may extract the coded depth and the information about an encoding mode according to the predetermined data units. If the coded depth and the information about an encoding mode of a corresponding LCU are recorded according to predetermined data units, the predetermined data units to which the same coded depth and information about an encoding mode are assigned may be inferred to be the data units included in the same LCU.

The image data decoder 230 reconstructs the current picture by decoding the image data in each LCU based on the coded depth and the information about an encoding mode according to the LCUs. In other words, the image data decoder 230 may decode the encoded image data based on the extracted information about the partition type, the prediction mode, and the transformation unit for each coding unit from among the coding units having the tree structure included in each LCU. A decoding process may include a prediction including intra prediction and motion compensation, and an inverse transformation.

The image data decoder 230 may perform intra prediction or motion compensation according to a partition and a prediction mode of each coding unit, based on the information about the partition type and the prediction mode of the prediction unit of the coding unit according to coded depths.

In addition, the image data decoder 230 may read information about a transformation unit according to a tree structure for each coding unit so as to perform inverse transformation based on transformation units for each coding unit, for inverse transformation for each LCU. Via the inverse transformation, a pixel value of the space domain of the coding unit may be reconstructed.

The image data decoder 230 may determine a coded depth of a current LCU by using splitting information according to depths. If the splitting information indicates that image data is no longer split in the current depth, the current depth is the coded depth. Accordingly, the image data decoder 230 may decode encoded data in the current LCU by using the information about the partition type of the prediction unit, the information about the prediction mode, and the size information of the transformation unit for each coding unit corresponding to the depth.

In other words, data units containing the encoding information including the same splitting information may be gathered by observing the encoding information set assigned for the predetermined data unit from among the coding unit, the prediction unit, and the minimum unit, and the gathered data units may be considered to be one data unit to be decoded by the image data decoder 230 in the same encoding mode. As such, the current coding unit may be decoded by obtaining the information about the encoding mode for each coding unit.

Also, the video decoding apparatus 200 of FIG. 8 may perform operations of the video decoding apparatus 20 described above with reference to FIG. 2.

The receiver 210 may perform operations of the parser 22 of the video decoding apparatus 20. The image data and encoding information extractor 220 and the image data decoder 230 may perform operations of the intra predictor 24 of the video decoding apparatus 20.

When a prediction unit for intra prediction is determined according to coding units having a tree structure, the parser 22 may parse an MPM flag for prediction of an intra prediction mode, from a bitstream, according to prediction units. Current intra mode information may be parsed from a bitstream continuously to the MPM flag, without having to determine whether a left intra prediction mode and a top intra prediction mode are the same or different. The image data and encoding information extractor 220 may reconstruct a current intra prediction mode from parsed information, after completing the parsing of symbols of blocks including the MPM flag and the intra mode information. The current intra prediction mode may be predicted by using a fixed number of candidate intra prediction modes. The image data decoder 230 may perform intra prediction on a current prediction unit by using the reconstructed current intra prediction mode and residual data.

The image data and encoding information extractor 220 may determine the number of candidate intra prediction modes again per very picture.

The parser 22 may parse information indicating the fixed number of candidate intra prediction modes from a parameter of various data unit levels, such as a picture parameter set (PPS), a slice parameter set (SPS), a LCU level, a coding unit level, and a prediction unit level of a bitstream. In this case, the image data and encoding information extractor 220 may determine the number of candidate intra prediction modes indicated by the parsed information, according to data units corresponding to the parsed level.

However, the image data and encoding information extractor 220 may update the number of candidate intra prediction modes according to slices, according to LCU, according to coding units, or according to predetermined data units, such as prediction units, even when the information indicating the number of candidate intra prediction modes is not parsed.

The video decoding apparatus 200 may obtain information about a coding unit that generates the minimum encoding error when encoding is recursively performed for each LCU, and may use the information to decode the current picture. In other words, the coding units having the tree structure determined to be the optimum coding units in each LCU may be decoded. Also, the maximum size of a coding unit is determined considering a resolution and an amount of image data.

Accordingly, even if image data has high resolution and a large amount of data, the image data may be efficiently decoded and restored by using a size of a coding unit and an encoding mode, which are adaptively determined according to characteristics of the image data, by using information about an optimum encoding mode received from an encoder.

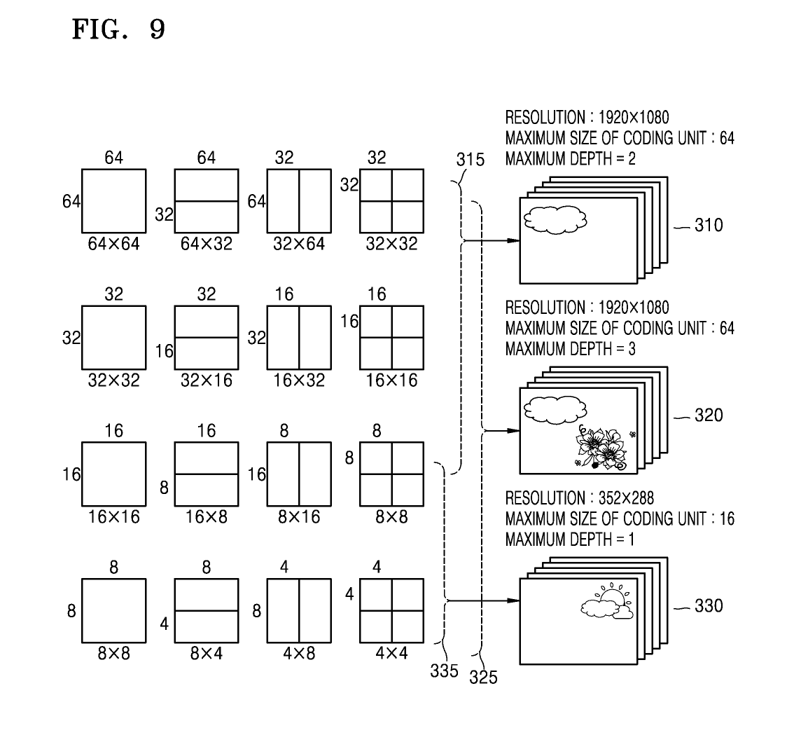

FIG. 9 is a diagram for describing a concept of coding units according to an embodiment.

A size of a coding unit may be expressed by width×height, and may be 64×64, 32×32, 16×16, and 8×8. A coding unit of 64×64 may be split into partitions of 64×64, 64×32, 32×64, or 32×32, and a coding unit of 32×32 may be split into partitions of 32×32, 32×16, 16×32, or 16×16, a coding unit of 16×16 may be split into partitions of 16×16, 16×8, 8×16, or 8×8, and a coding unit of 8×8 may be split into partitions of 8×8, 8×4, 4×8, or 4×4.

In video data 310, a resolution is 1920×1080, a maximum size of a coding unit is 64, and a maximum depth is 2. In video data 320, a resolution is 1920×1080, a maximum size of a coding unit is 64, and a maximum depth is 3. In video data 330, a resolution is 352×288, a maximum size of a coding unit is 16, and a maximum depth is 1. The maximum depth shown in FIG. 9 denotes a total number of splits from a LCU to a minimum decoding unit.

If a resolution is high or a data amount is large, a maximum size of a coding unit may be large so as to not only increase encoding efficiency but also to accurately reflect characteristics of an image. Accordingly, the maximum size of the coding unit of the video data 310 and 320 having a higher resolution than the video data 330 may be 64.

Since the maximum depth of the video data 310 is 2, coding units 315 of the vide data 310 may include a LCU having a long axis size of 64, and coding units having long axis sizes of 32 and 16 since depths are deepened to two layers by splitting the LCU twice. Since the maximum depth of the video data 330 is 1, coding units 335 of the video data 330 may include a LCU having a long axis size of 16, and coding units having a long axis size of 8 since depths are deepened to one layer by splitting the LCU once.

Since the maximum depth of the video data 320 is 3, coding units 325 of the video data 320 may include a LCU having a long axis size of 64, and coding units having long axis sizes of 32, 16, and 8 since the depths are deepened to 3 layers by splitting the LCU three times. As a depth deepens, detailed information may be precisely expressed.

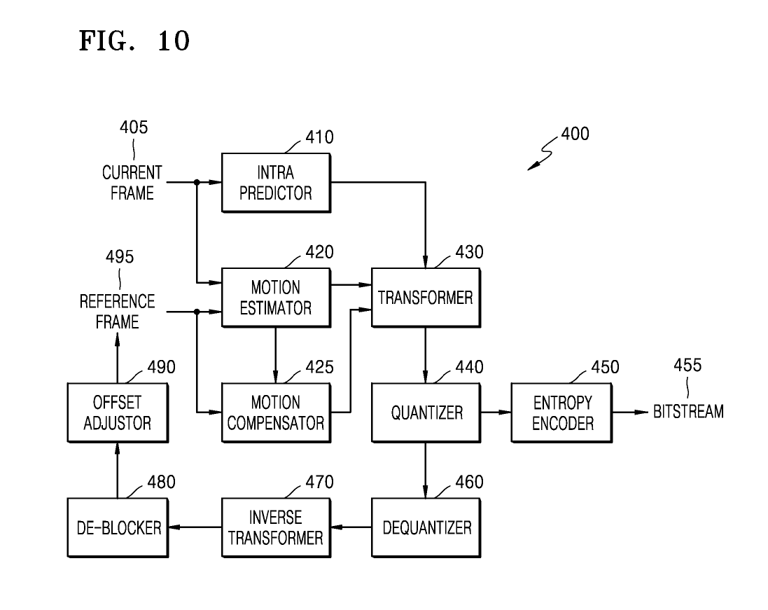

FIG. 10 is a block diagram of an image encoder 400 based on coding units, according to an embodiment of the present disclosure.

The image encoder 400 according to an embodiment performs operations necessary for encoding image data in the coding unit determiner 120 of the video encoding apparatus 100. In other words, an intra predictor 410 performs intra prediction on a coding unit in an intra mode from among a current frame 405, and a motion estimator 410 and a motion compensator 425 perform inter estimation and motion compensation by using the current frame 405 and a reference frame 495 in an inter mode.

Data output from the intra predictor 410, the motion estimator 420, and the motion compensator 425 is output as a quantized transformation coefficient through a transformer 430 and a quantizer 440. The quantized transformation coefficient is reconstructed as data in a spatial domain through a dequantizer 460 and an inverse transformer 470, and the reconstructed data in the spatial domain is post-processed through a de-blocker 480 and a loop filter 490 and output to the reference frame 495. The quantized transformation coefficient may be output to a bitstream 455 through an entropy encoder 450.

In order for the video encoding apparatus 100 according to an embodiment to be applied, the components of the image encoder 400, i.e., the intra predictor 410, the motion estimator 420, the motion compensator 425, the transformer 430, the quantizer 440, the entropy encoder 450, the dequantizer 460, the inverse transformer 470, the de-blocker 480, and the loop filter 490, should all perform operations based on each of coding units having a tree structure in consideration of a maximum depth for each LCU.

In particular, the intra predictor 410, the motion estimator 420, and the motion compensator 425 determine partitions and a prediction mode of each coding unit from among the coding units having a tree structure while considering the maximum size and the maximum depth of a current LCU, and the transformer 430 determines the size of the transformation unit in each coding unit from among the coding units having a tree structure.

Specifically, the intra predictor 410 may perform operations of the intra predictor 12 of the video encoding apparatus 10. A prediction unit for intra prediction may be determined according to the coding units having a tree structure for each LCU, and intra prediction may be performed for each prediction unit.

Since a plurality of candidate intra prediction modes are determined when a current prediction unit and left/top prediction units are the same and when a left intra prediction mode and a top intra prediction mode are the same or different, the entropy encoder 450 may encode an MPM flag for each prediction unit, and then encode current intra mode information determined based on candidate intra prediction modes for the current prediction unit.

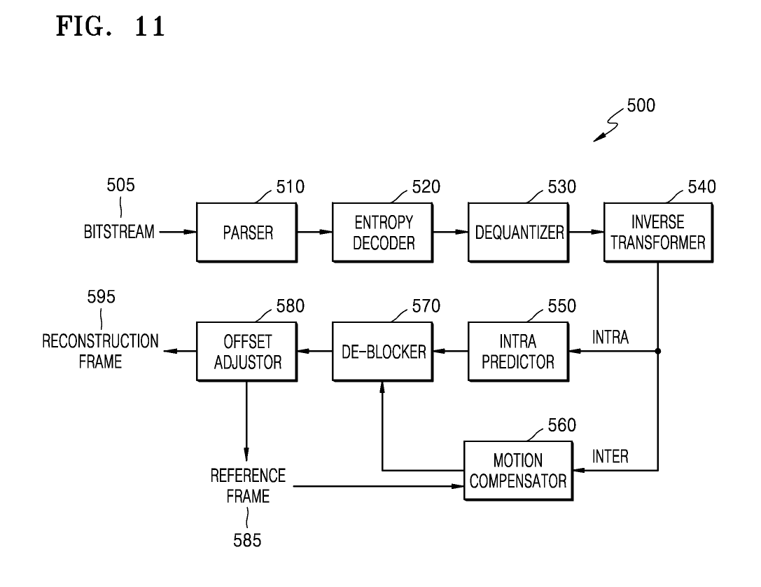

FIG. 11 is a block diagram of an image decoder 500 based on coding units, according to an embodiment of the present disclosure.

Encoded image data that is to be decoded and Information about encoding, which is required to decoding, are parsed as a bitstream 505 passes through a parser 510. The encoded image data is output as dequantized data through an entropy decoder 520 and a dequantizer 530, and image data in a spatial domain is reconstructed through an inverse transformer 540.

With respect to the image data in the spatial domain, an intra predictor 550 performs intra prediction on a coding unit in an intra mode, and a motion compensator 560 performs motion compensation on a coding unit in an inter mode by using a reference frame 585.

The data in the spatial domain that passed through the intra predictor 550 and the motion compensator 560 may be post-processed through a de-blocker 570 and a loop filter 580, and output to a reconstruction frame 595. Also, the data post-processed through the de-blocker 570 and the loop filter 580 may be output as the reference frame 585.

In order for the image data decoder 230 of the video decoding apparatus 200 to decode image data, operations after the parser 510 of the image decoder 500 according to an embodiment may be performed.

In order to be applied to the video decoding apparatus 200 according to an embodiment, the components of the image decoder 500, i.e., the parser 510, the entropy decoder 520, the dequantizer 530, the inverse transformer 540, the intra predictor 550, the motion compensator 560, the de-blocker 570, and the loop filter 580 should all perform operations based on coding units according to a tree structure for each LCU.

In particular, the intra predictor 550 and the motion compensator 560 determine a partition and a prediction mode for each of coding units according to a tree structure, and the inverse transformer 540 determines a size of a transformation unit for each coding unit.

Specifically, the parser 510 may parse an MPM flag for prediction of an intra prediction mode from a bitstream for each prediction unit, when a prediction unit for intra prediction is determined according to coding units according to a tree structure. Current intra mode information may be parsed from the bitstream continuously to the MPM flag without having to determine whether a left intra prediction mode and a top intra prediction mode are the same or different. After completing parsing of symbols of blocks including the MPM flag and the current intra mode information, the entropy decoder 520 may reconstruct a current intra prediction mode from the parsed information. The intra predictor 550 may perform intra prediction on a current prediction unit by using the reconstructed current intra prediction mode and residual data.

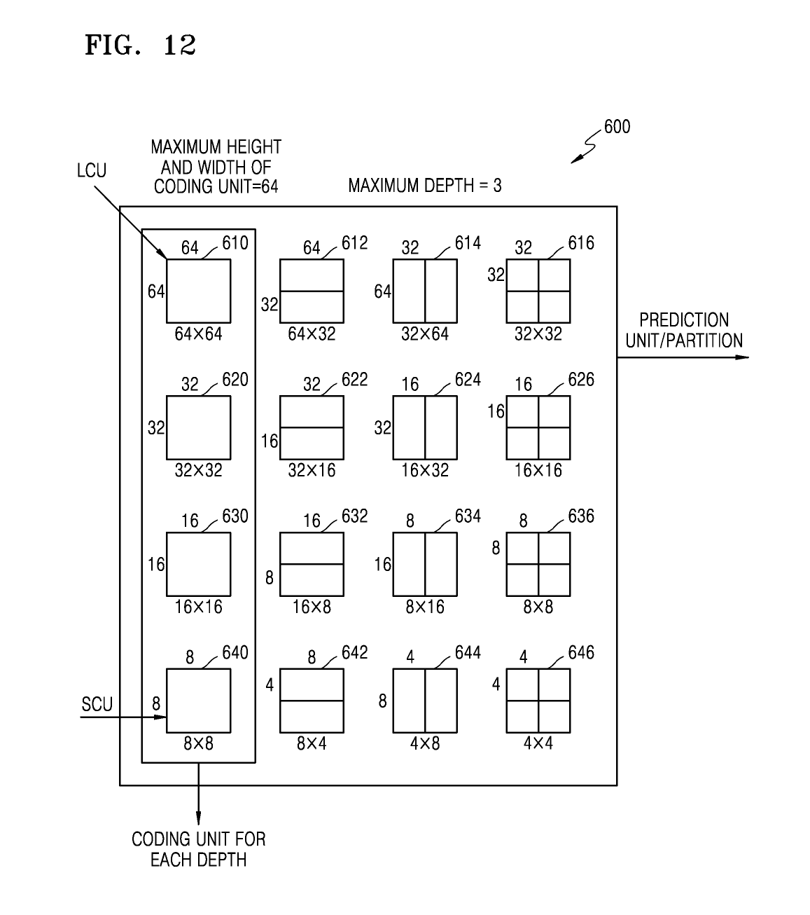

FIG. 12 is a diagram illustrating deeper coding units according to depths, and partitions, according to an embodiment of the present disclosure.

The video encoding apparatus 100 and the video decoding apparatus 200 use hierarchical coding units so as to consider characteristics of an image. A maximum height, a maximum width, and a maximum depth of coding units may be adaptively determined according to the characteristics of the image, or may be differently set by a user. Sizes of deeper coding units according to depths may be determined according to the predetermined maximum size of the coding unit.

In a hierarchical structure 600 of coding units, according to one or more embodiments, the maximum height and the maximum width of the coding units are each 64, and the maximum depth is 4. In this case, the maximum depth refers to a total number of times the coding unit is split from the LCU to the SCU. Since a depth deepens along a vertical axis of the hierarchical structure 600, a height and a width of the deeper coding unit are each split. Also, a prediction unit and partitions, which are bases for prediction encoding of each deeper coding unit, are shown along a horizontal axis of the hierarchical structure 600.

In other words, a coding unit 610 is a LCU in the hierarchical structure 600, wherein a depth is 0 and a size, i.e., a height by width, is 64×64. The depth deepens along the vertical axis, and a coding unit 620 having a size of 32×32 and a depth of 1, a coding unit 630 having a size of 16×16 and a depth of 2, a coding unit 640 having a size of 8×8 and a depth of 3, and a coding unit 650 having a size of 4×4 and a depth of 4 exist. The coding unit 650 having a size of 4×4 and a depth of 4 is an SCU.

The prediction unit and the partitions of a coding unit are arranged along the horizontal axis according to each depth. In other words, if the coding unit 610 having a size of 64×64 and a depth of 0 is a prediction unit, the prediction unit may be split into partitions included in the encoding unit 610 having the size of 64×64, i.e. a partition 610 having a size of 64×64, partitions 612 having the size of 64×32, partitions 614 having the size of 32×64, or partitions 616 having the size of 32×32.

Equally, a prediction unit of the coding unit 620 having the size of 32×32 and the depth of 1 may be split into partitions included in the coding unit 620 having the size of 32×32, i.e. a partition 620 having a size of 32×32, partitions 622 having a size of 32×16, partitions 624 having a size of 16×32, and partitions 626 having a size of 16×16.

Equally, a prediction unit of the coding unit 630 having the size of 16×16 and the depth of 2 may be split into partitions included in the coding unit 630 having the size of 16×16, i.e. a partition having a size of 16×16 included in the coding unit 630, partitions 632 having a size of 16×8, partitions 634 having a size of 8×16, and partitions 636 having a size of 8×8.

Equally, a prediction unit of the coding unit 640 having the size of 8×8 and the depth of 3 may be split into partitions included in the coding unit 640 having the size of 8×8, i.e. a partition having a size of 8×8 included in the coding unit 640, partitions 642 having a size of 8×4, partitions 644 having a size of 4×8, and partitions 646 having a size of 4×4.

Lastly, the coding unit 650 having the size of 4×4 and the depth of 4 is an SCU and a coding unit of a lowest depth. A prediction unit of the coding unit 650 may also be set only to a partition 650 having a size of 4×4.

In order to determine a coded depth of the coding units constituting the LCU 610, the coding unit determiner 120 of the video encoding apparatus 100 performs encoding for coding units corresponding to each depth included in the LCU 610.

A number of deeper coding units according to depths including data in the same range and the same size increases as the depth deepens. For example, four coding units corresponding to a depth of 2 are required to cover data that is included in one coding unit corresponding to a depth of 1. Accordingly, in order to compare encoding results of the same data according to depths, the coding unit corresponding to the depth of 1 and four coding units corresponding to the depth of 2 are each encoded.

In order to perform encoding for a current depth from among the depths, a least encoding error may be selected for the current depth by performing encoding for each prediction unit in the coding units corresponding to the current depth, along the horizontal axis of the hierarchical structure 600. Alternatively, the minimum encoding error may be searched for by comparing the least encoding errors according to depths, by performing encoding for each depth as the depth deepens along the vertical axis of the hierarchical structure 600. A depth and a partition having the minimum encoding error in the coding unit 610 may be selected as the coded depth and a partition type of the coding unit 610.

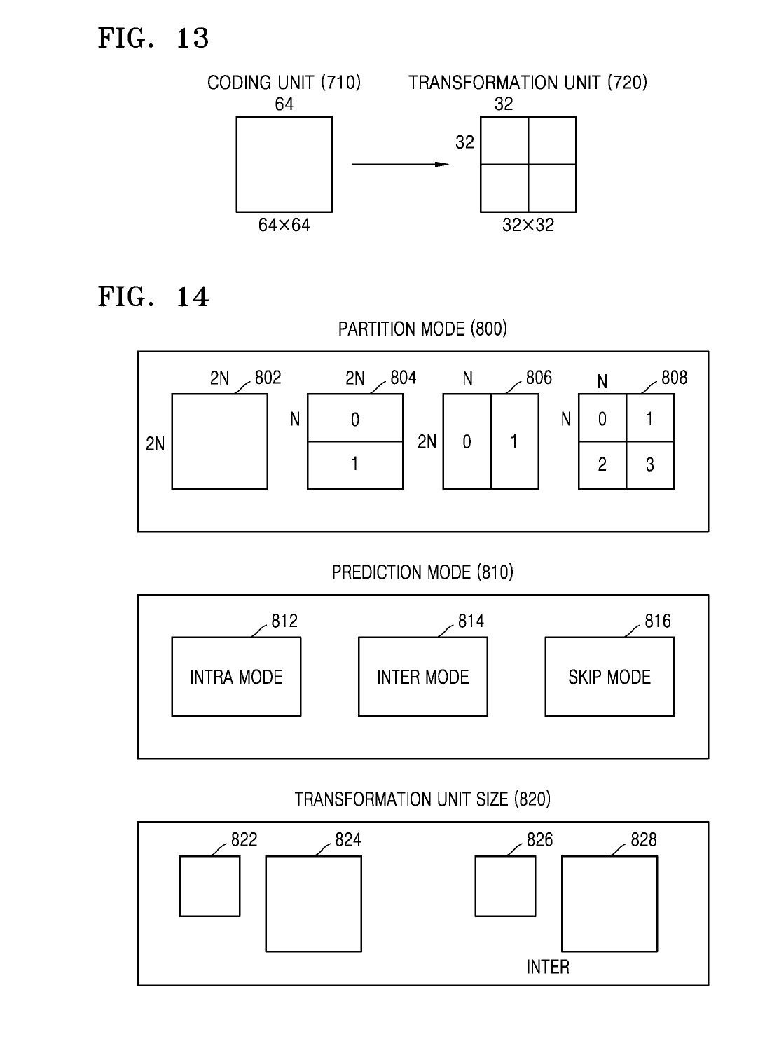

FIG. 13 is a diagram for describing a relationship between a coding unit 710 and transformation units 720, according to an embodiment.

The video encoding apparatus 100 or the video decoding apparatus 200 encodes or decodes an image according to coding units having sizes smaller than or equal to a LCU for each LCU. Sizes of transformation units for transformation during encoding may be selected based on data units that are not larger than a corresponding coding unit.

For example, in the video encoding apparatus 100 or the video decoding apparatus 200, if a size of the coding unit 710 is 64×64, transformation may be performed by using the transformation units 720 having a size of 32×32.

Also, data of the coding unit 710 having the size of 64×64 may be encoded by performing the transformation on each of the transformation units having the size of 32×32, 16×16, 8×8, and 4×4, which are smaller than 64×64, and then a transformation unit having the least coding error may be selected.

FIG. 14 is a diagram fro describing encoding information of coding units corresponding to a depth, according to an embodiment.

The outputter 130 of the video encoding apparatus 100 may encode and transmit information 800 about a partition type, information 810 about a prediction mode, and information 820 about a size of a transformation unit for each coding unit corresponding to a coded depth, as information about an encoding mode.

The information 800 indicates information about a mode of a partition obtained by splitting a prediction unit of a current coding unit, wherein the partition is a data unit for prediction encoding the current coding unit. For example, a current coding unit CU_0 having a size of 2N×2N may be split into any one of a partition 802 having a size of 2N×2N, a partition 804 having a size of 2N×N, a partition 806 having a size of N×2N, and a partition 808 having a size of N×N. Here, the information 800 about the partition type is set to indicate one of the partition 804 having a size of 2N×N, the partition 806 having a size of N×2N, and the partition 808 having a size of N×N.

The information 810 indicates a prediction mode of each partition. For example, the information 810 may indicate a mode of prediction encoding performed on a partition indicated by the information 800, i.e., an intra mode 812, an inter mode 814, or a skip mode 816.

The information 820 indicates a transformation unit to be based on when transformation is performed on a current coding unit. For example, the transformation unit may be a first intra transformation unit 822, a second intra transformation unit 824, a first inter transformation unit 826, or a second intra transformation unit 828.

The image data and encoding information extractor 220 of the video decoding apparatus 200 may extract and use the information 800, 810, and 820 for decoding, according to each deeper coding unit.

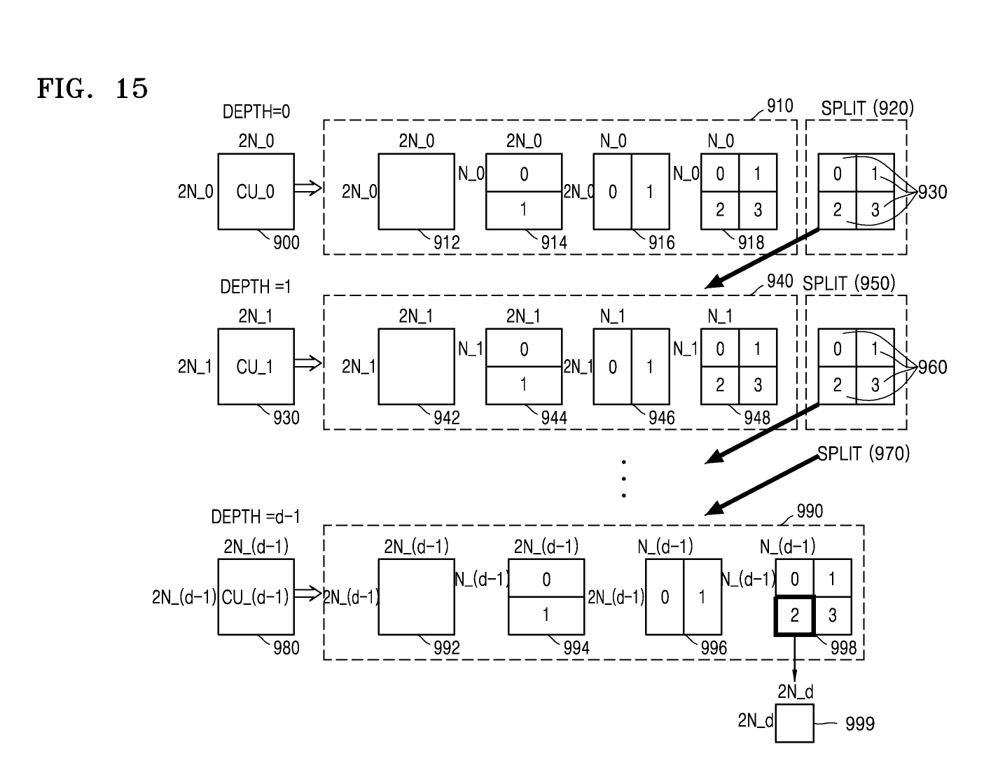

FIG. 15 is a diagram of deeper coding units according to depths, according to an embodiment.

Splitting information may be used to indicate a change of a depth. The spilt information indicates whether a coding unit of a current depth is split into coding units of a lower depth.

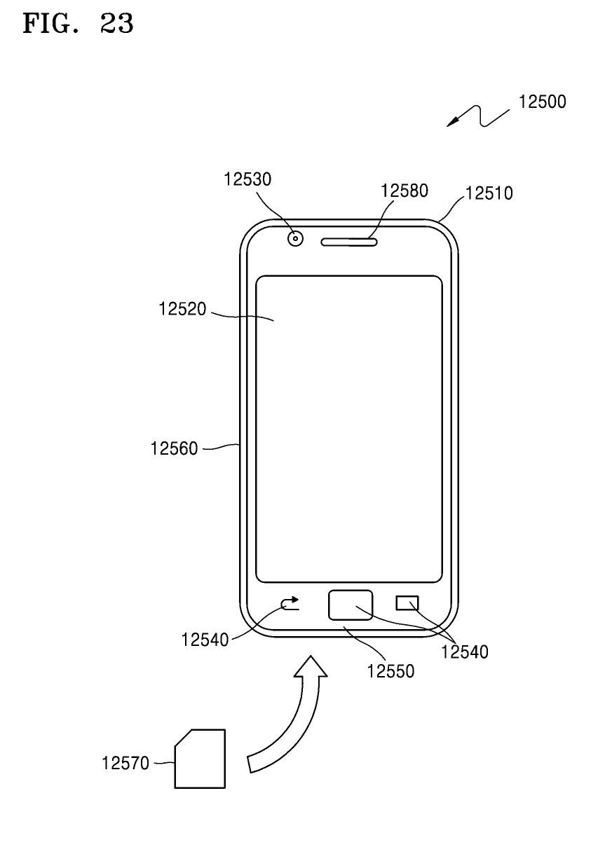

A prediction unit 910 for prediction encoding a coding unit 900 having a depth of 0 and a size of 2N_0×2N_0 may include partitions of a partition type 912 having a size of 2N_0×2N_0, a partition type 914 having a size of 2N_0×N_0, a partition type 916 having a size of N_0×2N_0, and a partition type 918 having a size of N_0×N_0. FIG. 23 only illustrates the partition types 912 through 918 which are obtained by symmetrically splitting the prediction unit 910, but a partition type is not limited thereto, and the partitions of the prediction unit 910 may include asymmetrical partitions, partitions having a predetermined shape, and partitions having a geometrical shape.

Prediction encoding is repeatedly performed on one partition having a size of 2N_0×2N_0, two partitions having a size of 2N_0×N_0, two partitions having a size of N_0×2N_0, and four partitions having a size of N_0×N_0, according to each partition type. The prediction encoding in an intra mode and an inter mode may be performed on the partitions having the sizes of 2N_0×2N_0, N_0×2N_0, 2N_0×N_0, and N_0×N_0. The prediction encoding in a skip mode is performed only on the partition having the size of 2N_0×2N_0.

If an encoding error is smallest in one of the partition types 912 through 916, the prediction unit 910 may not be split into a lower depth.

If the encoding error is the smallest in the partition type 918, a depth is changed from 0 to 1 to split the partition type 918 in operation 920, and encoding is repeatedly performed on coding units 930 having a depth of 2 and a size of N_0×N_0 to search for a minimum encoding error.

A prediction unit 940 for prediction encoding the coding unit 930 having a depth of 1 and a size of 2N_1×2N_1 (=N_0×N_0) may include partitions of a partition type 942 having a size of 2N_1×2N_1, a partition type 944 having a size of 2N_1×N_1, a partition type 946 having a size of N_1×2N_1, and a partition type 948 having a size of N_1×N_1.

If an encoding error is the smallest in the partition type 948, a depth is changed from 1 to 2 to split the partition type 948 in operation 950, and encoding is repeatedly performed on coding units 960, which have a depth of 2 and a size of N_2×N_2 to search for a minimum encoding error.

When a maximum depth is d, split operation according to each depth may be performed up to when a depth becomes d-1, and splitting information may be encoded as up to when a depth becomes d-2. In other words, when encoding is performed up to when the depth is d-1 after a coding unit corresponding to a depth of d-2 is split in operation 970, a prediction unit 990 for prediction encoding a coding unit 980 having a depth of d-1 and a size of 2N_(d-1)×2N_(d-1) may include partitions of a partition type 992 having a size of 2N_(d-1)×2N_(d-1), a partition type 994 having a size of 2N_(d-1)×N_(d-1), a partition type 996 having a size of N_(d-1)×2N_(d-1), and a partition type 998 having a size of N_(d-1)×N_(d-1).

Prediction encoding may be repeatedly performed on one partition having a size of 2N_(d-1)×2N_(d-1), two partitions having a size of 2N_(d-1)×N_(d-1), two partitions having a size of N_(d-1)×2N_(d-1), four partitions having a size of N_(d-1)×N_(d-1) from among the partition types 992 through 998 to search for a partition type having a minimum encoding error.

Even when the partition type 998 has the minimum encoding error, since a maximum depth is d, a coding unit CU_(d-1) having a depth of d-1 is no longer split to a lower depth, and a depth for the coding units constituting a current LCU 900 is determined to be d-1 and a partition type of the current LCU 900 may be determined to be N_(d-1)×N_(d-1). Also, since the maximum depth is d and an SCU 980 having a lowermost depth of d-1 is no longer split to a lower depth, splitting information for the SCU 980 is not set.

A data unit 999 may be a ‘minimum unit’ for the current LCU. A minimum unit according to an embodiment may be a square data unit obtained by splitting an SCU 980 by 4. By performing the encoding repeatedly, the video encoding apparatus 100 may select a depth having the least encoding error by comparing encoding errors according to depths of the coding unit 900 to determine a coded depth, and set a corresponding partition type and a prediction mode as an encoding mode of the depth.

As such, the minimum encoding errors according to depths are compared in all of the depths of 1 through d, and a depth having the least encoding error may be determined as a coded depth. The coded depth, the partition type of the prediction unit, and the prediction mode may be encoded and transmitted as information about an encoding mode. Also, since a coding unit is split from a depth of 0 to a coded depth, only splitting information of the coded depth is set to 0, and splitting information of depths excluding the coded depth is set to 1.

The image data and encoding information extractor 220 of the video decoding apparatus 200 may extract and use the information about the coded depth and the prediction unit of the coding unit 900 to decode the partition 912. The video decoding apparatus 200 may determine a coded depth, in which splitting information is 0, as a depth by using splitting information according to depths, and use information about an encoding mode of the corresponding depth for decoding.

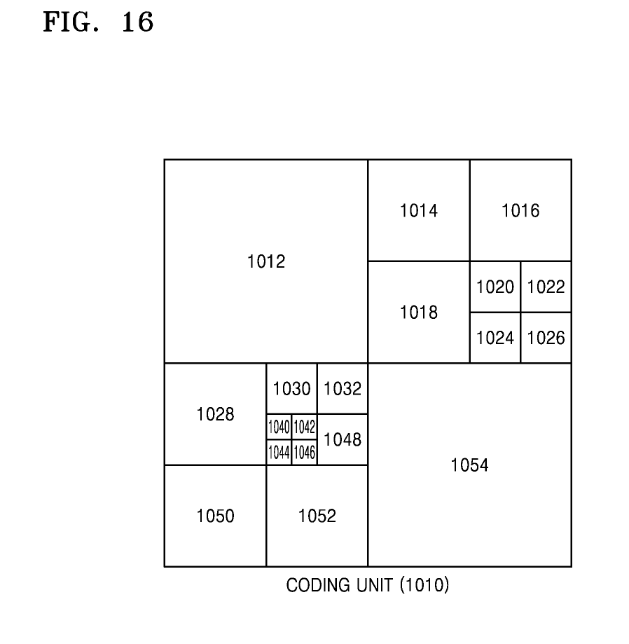

FIGS. 16 through 18 are diagrams for describing a relationship between coding units 1010, prediction units 1060, and transformation units 1070, according to an embodiment.

The coding units 1010 are coding units having a tree structure, corresponding to coded depths determined by the video encoding apparatus 100, in a LCU. The prediction units 1060 are partitions of prediction units of each of the coding units 1010, and the transformation units 1070 are transformation units of each of the coding units 1010.

When a depth of a LCU is 0 in the coding units 1010, depths of coding units 1012 and 1054 are 1, depths of coding units 1014, 1016, 1018, 1028, 1050, and 1052 are 2, depths of coding units 1020, 1022, 1024, 1026, 1030, 1032, and 1048 are 3, and depths of coding units 1040, 1042, 1044, and 1046 are 4.

In the prediction units 1060, some encoding units 1014, 1016, 1022, 1032, 1048, 1050, 1052, and 1054 are obtained by splitting the coding units in the encoding units 1010. In other words, partition types in the coding units 1014, 1022, 1050, and 1054 have a size of 2N×N, partition types in the coding units 1016, 1048, and 1052 have a size of N×2N, and a partition type of the coding unit 1032 has a size of N×N. Prediction units and partitions of the coding units 1010 are smaller than or equal to each coding unit.

Transformation or inverse transformation is performed on image data of the coding unit 1052 in the transformation units 1070 in a data unit that is smaller than the coding unit 1052. Also, the coding units 1014, 1016, 1022, 1032, 1048, 1050, and 1052 in the transformation units 1070 are data units different from those in the prediction units 1060 in terms of sizes and shapes. In other words, the video encoding and decoding apparatuses 100 and 200 may perform intra prediction, motion estimation, motion compensation, transformation, and inverse transformation on an individual data unit in the same coding unit.

Accordingly, encoding is recursively performed on each of coding units having a hierarchical structure in each region of a LCU to determine an optimum coding unit, and thus coding units having a recursive tree structure may be obtained. Encoding information may include splitting information about a coding unit, information about a partition type, information about a prediction mode, and information about a size of a transformation unit. Table 4 shows the encoding information that may be set by the video encoding and decoding apparatuses 100 and 200.

TABLE 4

| Splitting information 0 | | | | | |
|---|---|---|---|---|---|
| (Encoding on Coding Unit having Size of 2N × 2N and Current Depth of d) | | | | | |
| | Partition Type | | Size of Transformation Unit | | |
| | | | Splitting | Splitting | |
| | Symmetrical | Asymmetrical | information 0 of | information 1 of | |
| Prediction | Partition | Partition | Transformation | Transformation | Splitting |
| Mode | Type | Type | Unit | Unit | information 1 |
| Intra Inter | 2N × 2N | 2N × nU | 2N × 2N | N × N | Repeatedly |
| Skip | 2N × N | 2N × nD | | (Symmetrical | Encode |
| (Only | N × 2N | nL × 2N | | Type) | Coding Units |
| 2N × 2N) | N × N | nR × 2N | | N/2 × N/2 | having Lower |
| | | | | (Asymmetrical | Depth of d + 1 |
| | | | | Type) | |

The outputter 130 of the video encoding apparatus 100 may output the encoding information about the coding units having a tree structure, and the image data and encoding information extractor 220 of the video decoding apparatus 200 may extract the encoding information about the coding units having a tree structure from a received bitstream.

Splitting information indicates whether a current coding unit is split into coding units of a lower depth. If splitting information of a current depth d is 0, a depth, in which a current coding unit is no longer split into a lower depth, is a coded depth, and thus information about a partition type, prediction mode, and a size of a transformation unit may be defined for the coded depth. If the current coding unit is further split according to the splitting information, encoding is independently performed on four split coding units of a lower depth.

A prediction mode may be one of an intra mode, an inter mode, and a skip mode. The intra mode and the inter mode may be defined in all partition types, and the skip mode is defined only in a partition type having a size of 2N×2N.

The information about the partition type may indicate symmetrical partition types having sizes of 2N×2N, 2N×N, N×2N, and N×N, which are obtained by symmetrically splitting a height or a width of a prediction unit, and asymmetrical partition types having sizes of 2N×nU, 2N×nD, nL×2N, and nR×2N, which are obtained by asymmetrically splitting the height or width of the prediction unit. The asymmetrical partition types having the sizes of 2N×nU and 2N×nD may be respectively obtained by splitting the height of the prediction unit in 1:3 and 3:1, and the asymmetrical partition types having the sizes of nL×2N and nR×2N may be respectively obtained by splitting the width of the prediction unit in 1:3 and 3:1

The size of the transformation unit may be set to be two types in the intra mode and two types in the inter mode. In other words, if splitting information of the transformation unit is 0, the size of the transformation unit may be 2N×2N, which is the size of the current coding unit. If splitting information of the transformation unit is 1, the transformation units may be obtained by splitting the current coding unit. Also, if a partition type of the current coding unit having the size of 2N×2N is a symmetrical partition type, a size of a transformation unit may be N×N, and if the partition type of the current coding unit is an asymmetrical partition type, the size of the transformation unit may be N/2×N/2.

The encoding information about coding units having a tree structure may include at least one of a coding unit corresponding to a coded depth, a prediction unit, and a minimum unit. The coding unit corresponding to the coded depth may include at least one of a prediction unit and a minimum unit containing the same encoding information.

Accordingly, it is determined whether adjacent data units are included in the same coding unit corresponding to the coded depth by comparing encoding information of the adjacent data units. Also, a corresponding coding unit corresponding to a coded depth is determined by using encoding information of a data unit, and thus a distribution of coded depths in a LCU may be determined.

Accordingly, if a current coding unit is predicted based on encoding information of adjacent data units, encoding information of data units in deeper coding units adjacent to the current coding unit may be directly referred to and used.

Alternatively, if a current coding unit is predicted based on encoding information of adjacent data units, data units adjacent to the current coding unit are searched using encoded information of the data units, and the searched adjacent coding units may be referred for predicting the current coding unit.

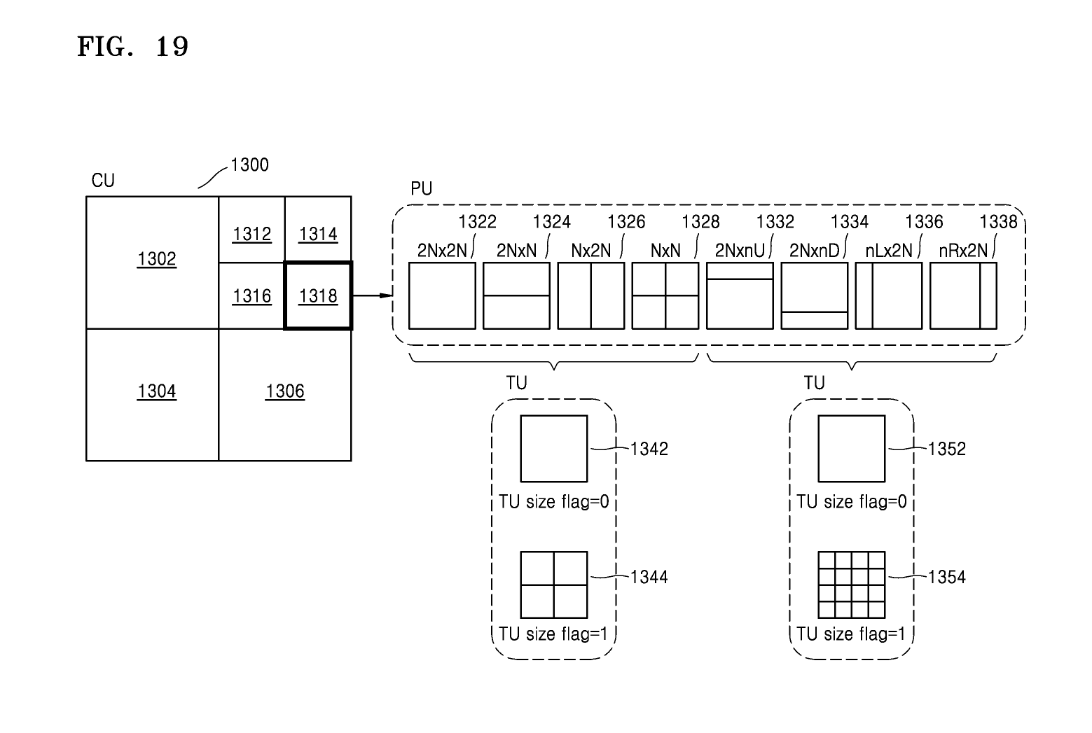

FIG. 19 is a diagram for describing a relationship between a coding unit, a prediction unit, and a transformation unit, according to encoding mode information of Table 1.

A LCU 1300 includes coding units 1302, 1304, 1306, 1312, 1314, 1316, and 1318 of coded depths. Here, since the coding unit 1318 is a coding unit of a coded depth, splitting information may be set to 0. Information about a partition type of the coding unit 1318 having a size of 2N×2N may be set to be one of a partition type 1322 having a size of 2N×2N, a partition type 1324 having a size of 2N×N, a partition type 1326 having a size of N×2N, a partition type 1328 having a size of N×N, a partition type 1332 having a size of 2N×nU, a partition type 1334 having a size of 2N×nD, a partition type 1336 having a size of nL×2N, and a partition type 1338 having a size of nR×2N.

Splitting information (TU size flag) of a transformation unit is a type of a transformation index. The size of the transformation unit corresponding to the transformation index may be changed according to a prediction unit type or partition type of the coding unit.

For example, when the partition type is set to be symmetrical, i.e. the partition type 1322, 1324, 1326, or 1328, a transformation unit 1342 having a size of 2N×2N is set if a TU size flag of a transformation unit is 0, and a transformation unit 1344 having a size of N×N is set if a TU size flag is 1.

When the partition type is set to be asymmetrical, i.e., the partition type 1332, 1334, 1336, or 1338, a transformation unit 1352 having a size of 2N×2N is set if a TU size flag is 0, and a transformation unit 1354 having a size of N/2×N/2 is set if a TU size flag is 1.

Referring to FIG. 21, the TU size flag is a flag having a value or 0 or 1, but the TU size flag is not limited to 1 bit, and a transformation unit may be hierarchically split having a tree structure while the TU size flag increases from 0. Splitting information (TU size flag) of a transformation unit may be an example of a transformation index.

In this case, the size of a transformation unit that has been actually used may be expressed by using a TU size flag of a transformation unit, according to one or more embodiments, together with a maximum size and minimum size of the transformation unit. The video encoding apparatus 100 is capable of encoding maximum transformation unit size information, minimum transformation unit size information, and a maximum TU size flag. The result of encoding the maximum transformation unit size information, the minimum transformation unit size information, and the maximum TU size flag may be inserted into an SPS. The video decoding apparatus 200 may decode video by using the maximum transformation unit size information, the minimum transformation unit size information, and the maximum TU size flag.

For example, (a) if the size of a current coding unit is 64×64 and a maximum transformation unit size is 32×32, (a-1) then the size of a transformation unit may be 32×32 when a TU size flag is 0, (a-2) may be 16×16 when the TU size flag is 1, and (a-3) may be 8×8 when the TU size flag is 2.

As another example, (b) if the size of the current coding unit is 32×32 and a minimum transformation unit size is 32×32, (b-1) then the size of the transformation unit may be 32×32 when the TU size flag is 0. Here, the TU size flag cannot be set to a value other than 0, since the size of the transformation unit cannot be less than 32×32.

As another example, (c) if the size of the current coding unit is 64×64 and a maximum TU size flag is 1, then the TU size flag may be 0 or 1. Here, the TU size flag cannot be set to a value other than 0 or 1.

Thus, if it is defined that the maximum TU size flag is ‘MaxTransformSizelndex’, a minimum transformation unit size is ‘MinTransformSize’, and a transformation unit size is ‘RootTuSize’ when the TU size flag is 0, then a current minimum transformation unit size ‘CurrMinTuSize’ that can be determined in a current coding unit, may be defined by Equation (1):

CurrMinTuSize=max (MinTransformSize, RootTuSize/(2̂MaxTransformSizeIndex)) (1)

Compared to the current minimum transformation unit size ‘CurrMinTuSize’ that can be determined in the current coding unit, a transformation unit size ‘RootTuSize’ when the TU size flag is 0 may denote a maximum transformation unit size that can be selected in the system. In Equation (1), ‘RootTuSize/(2̂MaxTransformSizelndex)’ denotes a transformation unit size when the transformation unit size ‘RootTuSize’, when the TU size flag is 0 , is split a number of times corresponding to the maximum TU size flag, and ‘MinTransformSize’ denotes a minimum transformation size. Thus, a smaller value from among ‘RootTuSize/(2̂MaxTransformSizelndex)’ and ‘MinTransformSize’ may be the current minimum transformation unit size ‘CurrMinTuSize’ that can be determined in the current coding unit.

According to one or more embodiments, the maximum transformation unit size RootTuSize may vary according to the type of a prediction mode.

For example, if a current prediction mode is an inter mode, then ‘RootTuSize’ may be determined by using Equation (2) below. In Equation (2), ‘MaxTransformSize’ denotes a maximum transformation unit size, and ‘PUSize’ denotes a current prediction unit size.

RootTuSize=min(MaxTransformSize, PUSize) (2)

That is, if the current prediction mode is the inter mode, the transformation unit size ‘RootTuSize’, when the TU size flag is 0, may be a smaller value from among the maximum transformation unit size and the current prediction unit size.

If a prediction mode of a current partition unit is an intra mode, ‘RootTuSize’ may be determined by using Equation (3) below. In Equation (3), ‘PartitionSize’ denotes the size of the current partition unit.

RootTuSize=min(MaxTransformSize, PartitionSize) (3)

That is, if the current prediction mode is the intra mode, the transformation unit size ‘RootTuSize’ when the TU size flag is 0 may be a smaller value from among the maximum transformation unit size and the size of the current partition unit.

However, the current maximum transformation unit size ‘RootTuSize’ that varies according to the type of a prediction mode in a partition unit is just an example and the embodiments are not limited thereto.

According to the video encoding method based on coding units having a tree structure as described with reference to FIGS. 7 through 19, image data of the space domain is encoded for each coding unit of a tree structure. According to the video decoding method based on coding units having a tree structure, decoding is performed for each LCU to reconstruct image data of the space domain. Thus, a picture and a video that is a picture sequence may be reconstructed. The reconstructed video may be reproduced by a reproducing apparatus, stored in a storage medium, or transmitted through a network.

The embodiments may be written as computer programs and may be implemented in general-use digital computers that execute the programs using a computer-readable recording medium. Examples of the computer-readable recording medium include magnetic storage media (e.g., ROM, floppy discs, hard discs, etc.) and optical recording media (e.g., CD-ROMs, or DVDs).

For convenience of description, the video encoding method and/or the video encoding method described above with reference to FIGS. 1A through 19, will be referred to as a ‘video encoding method according to the various embodiments’. In addition, the video decoding method and/or the video decoding method described above with reference to FIGS. 1 A through 19, will be referred to as a ‘video decoding method according to the various embodiments’.

A video encoding apparatus including the video encoding apparatus, the video encoding apparatus, or the video encoder, which is described above with reference to FIGS. 1A through 19, will be referred to as a ‘video encoding apparatus according to the various embodiments’. In addition, a video decoding apparatus including the inter-layer video decoding apparatus, the video decoding apparatus, or the video decoder, which is described above with reference to FIGS. 1A through 19, will be referred to as a ‘video decoding apparatus according to the various embodiments’.

The computer-readable recording medium such as a disc 26000 that stores a program,according to various embodiments will now be described in detail.

FIG. 20 is a diagram of a physical structure of the disc 26000 in which a program is stored, according to an embodiment. The disc 26000, which is a storage medium, may be a hard drive, a compact disc-read only memory (CD-ROM) disc, a Blu-ray disc, or a digital versatile disc (DVD). The disc 26000 includes a plurality of concentric tracks Tr that are each divided into a specific number of sectors Se in a circumferential direction of the disc 26000. In a specific region of the disc 26000, a program that executes the quantization parameter determination method, the video encoding method, and the video decoding method described above may be assigned and stored.

A computer system embodied using the storage medium that stores the program for executing the video encoding method and the video decoding method as described above will now be described with reference to FIG. 21.

FIG. 21 is a diagram of a disc drive 26800 for recording and reading a program by using the disc 26000. A computer system 26700 may store a program that executes at least one of a video encoding method and a video decoding method according to one or more embodiments, in the disc 26000 via the disc drive 26800. To run the program stored in the disc 26000 in the computer system 26700, the program may be read from the disc 26000 and be transmitted to the computer system 26700 by using the disc drive 26700.

The program that executes at least one of a video encoding method and a video decoding method according to one or more embodiments may be stored not only in the disc 26000 illustrated in FIG. 20 or 21 but also in a memory card, a ROM cassette, or a solid state drive (SSD).

A system to which the video encoding method and a video decoding method described above are applied will be described below.

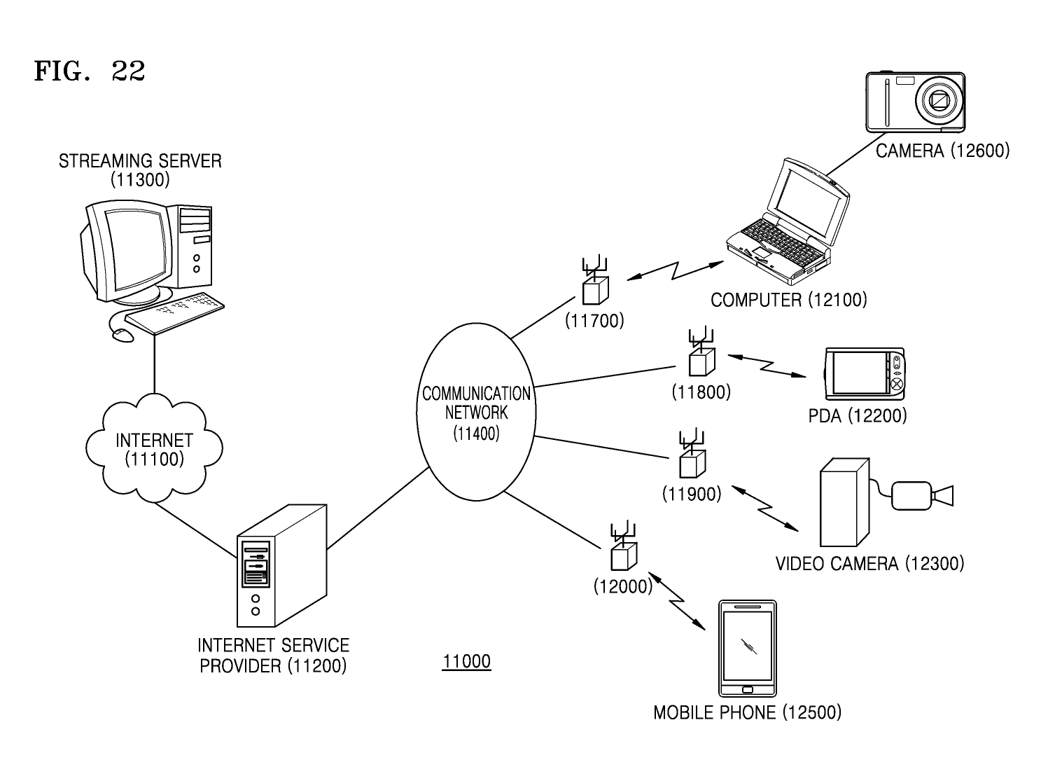

FIG. 22 is a diagram of an overall structure of a content supply system 11000 for providing a content distribution service. A service area of a communication system is divided into predetermined-sized cells, and wireless base stations 11700, 11800, 11900, and 12000 are installed in these cells, respectively.

The content supply system 11000 includes a plurality of independent devices. For example, the plurality of independent devices, such as a computer 12100, a personal digital assistant (PDA) 12200, a video camera 12300, and a mobile phone 12500, are connected to the Internet 11100 via an internet service provider 11200, a communication network 11400, and the wireless base stations 11700, 11800, 11900, and 12000.

However, the content supply system 11000 is not limited to as illustrated in FIG. 22, and devices may be selectively connected thereto. The plurality of independent devices may be directly connected to the communication network 11400, not via the wireless base stations 11700, 11800, 11900, and 12000.

The video camera 12300 is an imaging device, e.g., a digital video camera, which is capable of capturing video images. The mobile phone 12500 may employ at least one communication method from among various protocols, e.g., Personal Digital Communications (PDC), Code Division Multiple Access (CDMA), Wideband-Code Division Multiple Access (W-CDMA), Global System for Mobile Communications (GSM), and Personal Handyphone System (PHS).

The video camera 12300 may be connected to a streaming server 11300 via the wireless base station 11900 and the communication network 11400. The streaming server 11300 allows content received from a user via the video camera 12300 to be streamed via a real-time broadcast. The content received from the video camera 12300 may be encoded by the video camera 12300 or the streaming server 11300. Video data captured by the video camera 12300 may be transmitted to the streaming server 11300 via the computer 12100.

Video data captured by a camera 12600 may also be transmitted to the streaming server 11300 via the computer 12100. The camera 12600 is an imaging device capable of capturing both still images and video images, similar to a digital camera. The video data captured by the camera 12600 may be encoded using the camera 12600 or the computer 12100. Software that performs encoding and decoding video may be stored in a computer-readable recording medium, e.g., a CD-ROM disc, a floppy disc, a hard disc drive, an SSD, or a memory card, which may be accessible by the computer 12100.

If video data is captured by a camera built in the mobile phone 12500, the video data may be received from the mobile phone 12500.

The video data may also be encoded by a large scale integrated circuit (LSI) system installed in the video camera 12300, the mobile phone 12500, or the camera 12600.

The content supply system 11000 may encode content data recorded by a user using the video camera 12300, the camera 12600, the mobile phone 12500, or another imaging device, e.g., content recorded during a concert, and transmit the encoded content data to the streaming server 11300. The streaming server 11300 may transmit the encoded content data in a type of a streaming content to other clients that request the content data.

The clients are devices capable of decoding the encoded content data, e.g., the computer 12100, the PDA 12200, the video camera 12300, or the mobile phone 12500. Thus, the content supply system 11000 allows the clients to receive and reproduce the encoded content data. Also, the content supply system 11000 allows the clients to receive the encoded content data and decode and reproduce the encoded content data in real time, thereby enabling personal broadcasting.

The video encoding apparatus and the video decoding apparatus of the present disclosure may be applied to encoding and decoding operations of the plurality of independent devices included in the content supply system 11000.

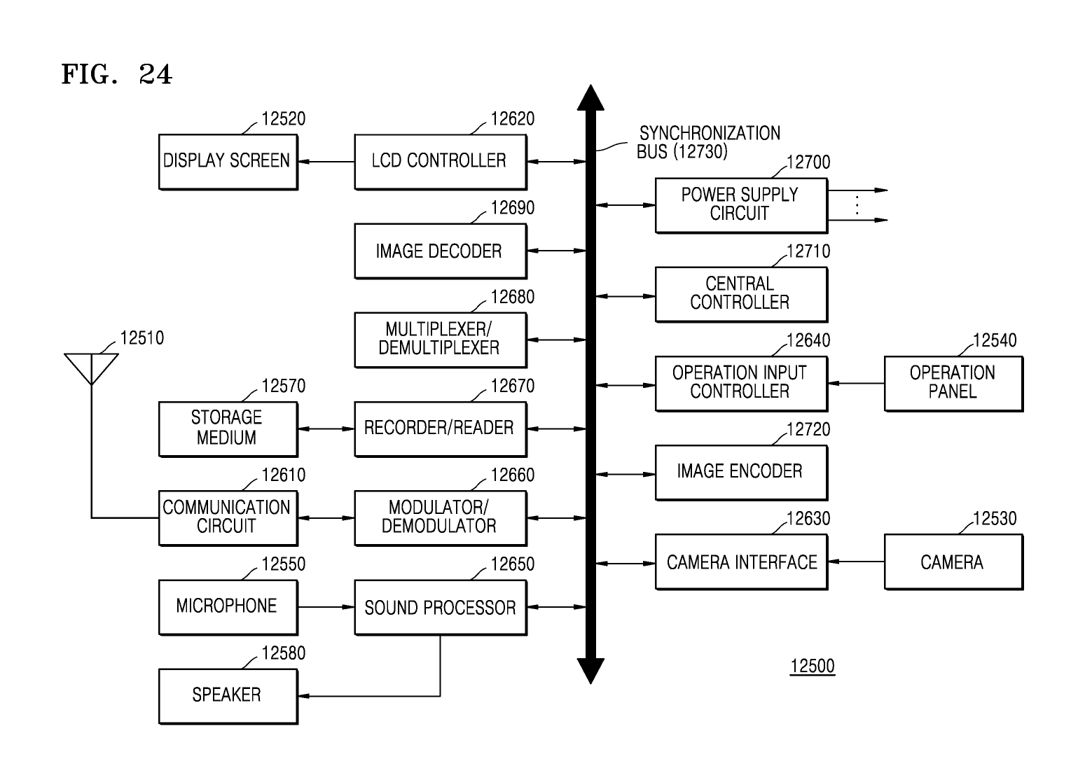

The mobile phone 12500 included in the content supply system 11000 according to one or more embodiments will now be described in greater detail with reference to FIGS. 23 and 24.

FIG. 23 illustrates an external structure of the mobile phone 12500 to which a video encoding method and a video decoding method are applied, according to an embodiment. The mobile phone 12500 may be a smart phone, the functions of which are not limited and a large number of the functions of which may be changed or expanded.

The mobile phone 12500 includes an internal antenna 12510 via which a radio-frequency (RF) signal may be exchanged with the wireless base station 12000 of FIG. 21, and includes a display screen 12520 for displaying images captured by a camera 12530 or images that are received via the antenna 12510 and decoded, e.g., a liquid crystal display (LCD) or an organic light-emitting diode (OLED) screen. The mobile phone 12500 includes an operation panel 12540 including a control button and a touch panel. If the display screen 12520 is a touch screen, the operation panel 12540 further includes a touch sensing panel of the display screen 12520. The mobile phone 12500 includes a speaker 12580 for outputting voice and sound or another type of sound outputter, and a microphone 12550 for inputting voice and sound or another type sound inputter. The mobile phone 12500 further includes the camera 12530, such as a charge-coupled device (CCD) camera, to capture video and still images. The mobile phone 12500 may further include a storage medium 12570 for storing encoded/decoded data, e.g., video or still images captured by the camera 12530, received via email, or obtained according to various ways; and a slot 12560 via which the storage medium 12570 is loaded into the mobile phone 12500. The storage medium 12570 may be a flash memory, e.g., a secure digital (SD) card or an electrically erasable and programmable read only memory (EEPROM) included in a plastic case.

FIG. 24 illustrates an internal structure of the mobile phone 12500, according to one or more embodiments. To systemically control parts of the mobile phone 12500 including the display screen 12520 and the operation panel 12540, a power supply circuit 12700, an operation input controller 12640, an image encoder 12720, a camera interface 12630, an LCD controller 12620, an image decoder 12690, a multiplexer/demultiplexer 12680, a recorder/reader 12670, a modulator/demodulator 12660, and a sound processor 12650 are connected to a central controller 12710 via a synchronization bus 12730.

If a user operates a power button and sets from a ‘power off’ state to a ‘power on’ state, the power supply circuit 12700 supplies power to all the parts of the mobile phone 12500 from a battery pack, thereby setting the mobile phone 12500 in an operation mode.

The central controller 12710 includes a central processing unit (CPU), a ROM, and a RAM.

While the mobile phone 12500 transmits communication data to the outside, a digital signal is generated by the mobile phone 12500 under control of the central controller 12710. For example, the sound processor 12650 may generate a digital sound signal, the video encoder 12720 may generate a digital image signal, and text data of a message may be generated via the operation panel 12540 and the operation input controller 12640. When a digital signal is transmitted to the modulator/demodulator 12660 under control of the central controller 12710, the modulator/demodulator 12660 modulates a frequency band of the digital signal, and a communication circuit 12610 performs digital-to-analog conversion (DAC) and frequency conversion on the frequency band-modulated digital sound signal. A transmission signal output from the communication circuit 12610 may be transmitted to a voice communication base station or the wireless base station 12000 via the antenna 12510.

For example, when the mobile phone 12500 is in a conversation mode, a sound signal obtained via the microphone 12550 is transformed into a digital sound signal by the sound processor 12650, under control of the central controller 12710. The digital sound signal may be transformed into a transformation signal via the modulator/demodulator 12660 and the communication circuit 12610, and may be transmitted via the antenna 12510.

When a text message, e.g., email, is transmitted in a data communication mode, text data of the text message is input via the operation panel 12540 and is transmitted to the central controller 12710 via the operation input controller 12640. Under control of the central controller 12710, the text data is transformed into a transmission signal via the modulator/demodulator 12660 and the communication circuit 12610 and is transmitted to the wireless base station 12000 via the antenna 12510.

To transmit image data in the data communication mode, image data captured by the camera 12530 is provided to the image encoder 12720 via the camera interface 12630. The captured image data may be directly displayed on the display screen 12520 via the camera interface 12630 and the LCD controller 12620.

A structure of the image encoder 12720 may correspond to that of the above-described video encoding method according to the one or more embodiments. The image encoder 12720 may transform the image data received from the camera 12530 into compressed and encoded image data based on the above-described video encoding method according to the one or more embodiments, and then output the encoded image data to the multiplexer/demultiplexer 12680. During a recording operation of the camera 12530, a sound signal obtained by the microphone 12550 of the mobile phone 12500 may be transformed into digital sound data via the sound processor 12650, and the digital sound data may be transmitted to the multiplexer/demultiplexer 12680.

The multiplexer/demultiplexer 12680 multiplexes the encoded image data received from the image encoder 12720, together with the sound data received from the sound processor 12650. A result of multiplexing the data may be transformed into a transmission signal via the modulator/demodulator 12660 and the communication circuit 12610, and may then be transmitted via the antenna 12510.

While the mobile phone 12500 receives communication data from the outside, frequency recovery and ADC are performed on a signal received via the antenna 12510 to transform the signal into a digital signal. The modulator/demodulator 12660 modulates a frequency band of the digital signal. The frequency-band modulated digital signal is transmitted to the video decoding unit 12690, the sound processor 12650, or the LCD controller 12620, according to the type of the digital signal.

In the conversation mode, the mobile phone 12500 amplifies a signal received via the antenna 12510, and obtains a digital sound signal by performing frequency conversion and ADC on the amplified signal. A received digital sound signal is transformed into an analog sound signal via the modulator/demodulator 12660 and the sound processor 12650, and the analog sound signal is output via the speaker 12580, under control of the central controller 12710.

When in the data communication mode, data of a video file accessed at an Internet website is received, a signal received from the wireless base station 12000 via the antenna 12510 is output as multiplexed data via the modulator/demodulator 12660, and the multiplexed data is transmitted to the multiplexer/demultiplexer 12680.

To decode the multiplexed data received via the antenna 12510, the multiplexer/demultiplexer 12680 demultiplexes the multiplexed data into an encoded video data stream and an encoded audio data stream. Via the synchronization bus 12730, the encoded video data stream and the encoded audio data stream are provided to the video decoding unit 12690 and the sound processor 12650, respectively.

A structure of the image decoder 12690 may correspond to that of the above-described video decoding method according to the one or more embodiments. The image decoder 12690 may decode the encoded video data to obtain reconstructed video data and provide the reconstructed video data to the display screen 12520 via the LCD controller 12620, by using the above-described video decoding method according to the one or more embodiments.

Thus, the data of the video file accessed at the Internet website may be displayed on the display screen 12520. At the same time, the sound processor 12650 may transform audio data into an analog sound signal, and provide the analog sound signal to the speaker 12580. Thus, audio data contained in the video file accessed at the Internet website may also be reproduced via the speaker 12580.

The mobile phone 12500 or another type of communication terminal may be a transceiving terminal including both a video encoding apparatus and a video decoding apparatus according to one or more embodiments, may be a transceiving terminal including only the video encoding apparatus, or may be a transceiving terminal including only the video decoding apparatus.

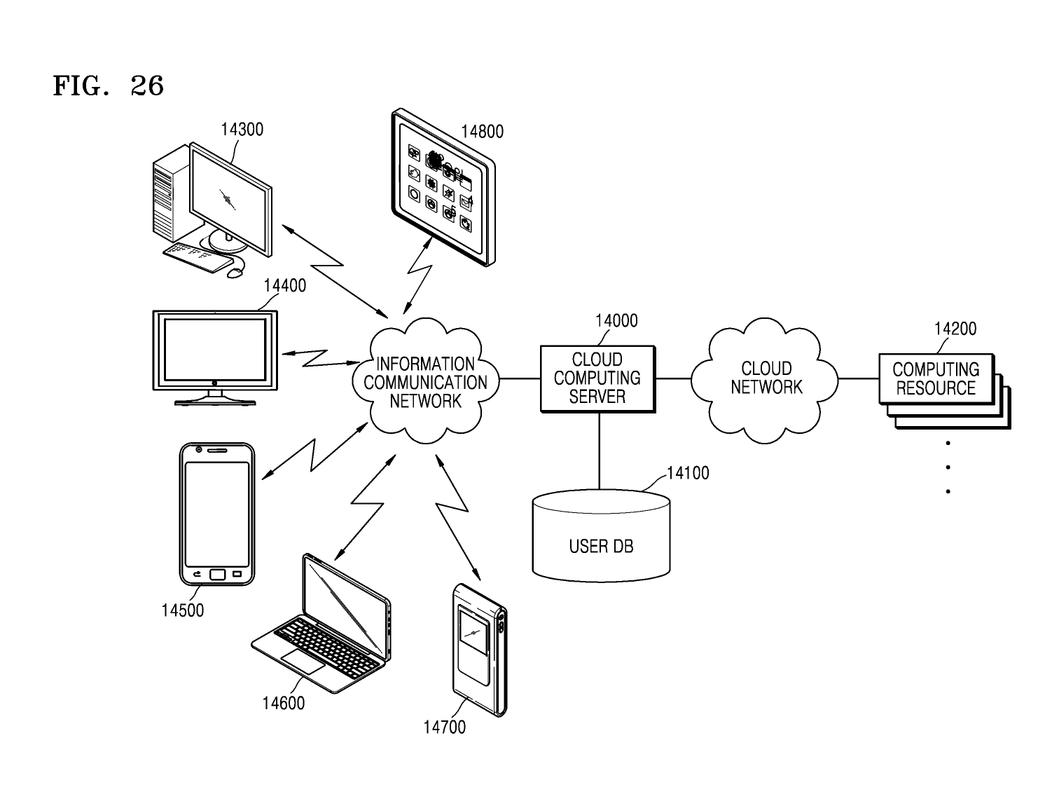

A communication system according to the one or more embodiments is not limited to the communication system described above with reference to FIG. 24. For example, FIG. 26 illustrates a digital broadcasting system employing a communication system, according to an embodiment.

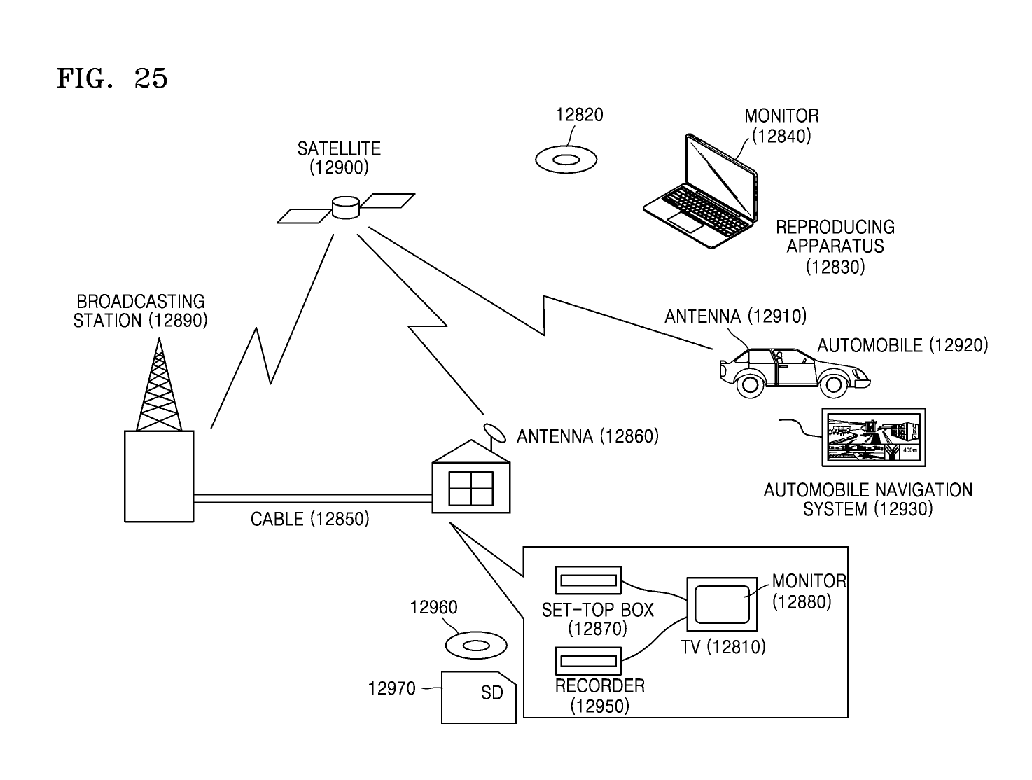

The digital broadcasting system of FIG. 25 may receive a digital broadcast transmitted via a satellite or a terrestrial network by using a video encoding apparatus and a video decoding apparatus according to one or more embodiments.

Specifically, a broadcasting station 12890 transmits a video data stream to a communication satellite or a broadcasting satellite 12900 by using radio waves. The broadcasting satellite 12900 transmits a broadcast signal, and the broadcast signal is transmitted to a satellite broadcast receiver via a household antenna 12860. In every house, an encoded video stream may be decoded and reproduced by a TV receiver 12810, a set-top box 12870, or another device.

When a video decoding apparatus according to one or more embodiments is implemented in a reproducing apparatus 12830, the reproducing apparatus 12830 may parse and decode an encoded video stream recorded on a storage medium 12820, such as a disc or a memory card to reconstruct digital signals. Thus, the reconstructed video signal may be reproduced, for example, on a monitor 12840.

In the set-top box 12870 connected to the antenna 12860 for a satellite/terrestrial broadcast or a cable antenna 12850 for receiving a cable television (TV) broadcast, a video decoding apparatus according to one or more embodiments may be installed. Data output from the set-top box 12870 may also be reproduced on a TV monitor 12880.

As another example, a video decoding apparatus according to one or more embodiments may be installed in the TV receiver 12810 instead of the set-top box 12870.

An automobile 12920 that has an appropriate antenna 12910 may receive a signal transmitted from the satellite 12900 or the wireless base station 11700. A decoded video may be reproduced on a display screen of an automobile navigation system 12930 installed in the automobile 12920.

A video signal may be encoded by a video encoding apparatus according to one or more embodiments and may then be recorded to and stored in a storage medium. Specifically, an image signal may be stored in a DVD disc 12960 by a DVD recorder or may be stored in a hard disc by a hard disc recorder 12950. As another example, the video signal may be stored in an SD card 12970. If the hard disc recorder 12950 includes a video decoding apparatus according to one or more embodiments, a video signal recorded on the DVD disc 12960, the SD card 12970, or another storage medium may be reproduced on the TV monitor 12880.

The automobile navigation system 12930 may not include the camera 12530 of FIG. 26, and the camera interface 12630 and the video encoder 12720 of FIG. 26. For example, the computer 12100 and the TV receiver 12810 may not include the camera 12530, the camera interface 12630, and the video encoder 12720.

FIG. 26 is a diagram illustrating a network structure of a cloud computing system using a video encoding apparatus and a video decoding apparatus, according to an embodiment.

The cloud computing system may include a cloud computing server 14000, a user database (DB) 14100, a plurality of computing resources 14200, and a user terminal.

The cloud computing system provides an on-demand outsourcing service of the plurality of computing resources 14200 via a data communication network, e.g., the Internet, in response to a request from the user terminal. Under a cloud computing environment, a service provider provides users with desired services by combining computing resources at data centers located at physically different locations by using virtualization technology. A service user does not have to install computing resources, e.g., an application, a storage, an operating system (OS), and security, into his/her own terminal in order to use them, but may select and use desired services from among services in a virtual space generated through the virtualization technology, at a desired point in time.

A user terminal of a specified service user is connected to the cloud computing server 14000 via a data communication network including the Internet and a mobile telecommunication network. User terminals may be provided cloud computing services, and particularly video reproduction services, from the cloud computing server 14000. The user terminals may be various types of electronic devices capable of being connected to the Internet, e.g., a desktop PC 14300, a smart TV 14400, a smart phone 14500, a notebook computer 14600, a portable multimedia player (PMP) 14700, a tablet PC 14800, and the like.

The cloud computing server 14000 may combine the plurality of computing resources 14200 distributed in a cloud network and provide user terminals with a result of combining. The plurality of computing resources 14200 may include various data services, and may include data uploaded from user terminals. As described above, the cloud computing server 14000 may provide user terminals with desired services by combining video database distributed in different regions according to the virtualization technology.

User information about users who have subscribed for a cloud computing service is stored in the user DB 14100. The user information may include logging information, addresses, names, and personal credit information of the users. The user information may further include indexes of videos. Here, the indexes may include a list of videos that have already been reproduced, a list of videos that are being reproduced, a pausing point of a video that was being reproduced, and the like.

Information about a video stored in the user DB 14100 may be shared between user devices. For example, when a video service is provided to the notebook computer 14600 in response to a request from the notebook computer 14600, a reproduction history of the video service is stored in the user DB 14100. When a request to reproduce this video service is received from the smart phone 14500, the cloud computing server 14000 searches for and reproduces this video service, based on the user DB 14100. When the smart phone 14500 receives a video data stream from the cloud computing server 14000, a process of reproducing video by decoding the video data stream is similar to an operation of the mobile phone 12500 described above with reference to FIG. 24.

The cloud computing server 14000 may refer to a reproduction history of a desired video service, stored in the user DB 14100. For example, the cloud computing server 14000 receives a request to reproduce a video stored in the user DB 14100, from a user terminal. If this video was being reproduced, then a method of streaming this video, performed by the cloud computing server 14000, may vary according to the request from the user terminal, i.e., according to whether the video will be reproduced, starting from a start thereof or a pausing point thereof. For example, if the user terminal requests to reproduce the video, starting from the start thereof, the cloud computing server 14000 transmits streaming data of the video starting from a first frame thereof to the user terminal. If the user terminal requests to reproduce the video, starting from the pausing point thereof, the cloud computing server 14000 transmits streaming data of the video starting from a frame corresponding to the pausing point, to the user terminal.

In this case, the user terminal may include a video decoding apparatus as described above with reference to FIGS. 1A through 19. As another example, the user terminal may include a video encoding apparatus as described above with reference to FIGS. 1A through 19. Alternatively, the user terminal may include both the video decoding apparatus and the video encoding apparatus as described above with reference to FIGS. 1 A through 19.

Various applications of a video encoding method, a video decoding method, a video encoding apparatus, and a video decoding apparatus according to an embodiment described above with reference to FIGS. 1A through 19 have been described above with reference to FIGS. 20 to 26. However, methods of storing the video encoding method and the video decoding method in a storage medium or methods of implementing the video encoding apparatus and the video decoding apparatus in a device, according to an embodiment, described above with reference to FIGS. 1A through 19 are not limited to the embodiments described above with reference to FIGS. 20 to 26.

The method, process, apparatus, product, and/or system of the present disclosure are simple, effective in terms of costs, not complicated, very various, and accurate. Also, the process, apparatus, product, and the system of the present disclosure may be immediately used by applying well-known components, and efficient and economical manufacture, application, and utilization may be realized. Another important aspect of the present disclosure is that the present disclosure suits the current trends requesting cost reduction, system simplification, and performance increase. Useful aspects of embodiments of the present disclosure may increase the level of at least the present technology as a result.

It should be understood that embodiments described herein should be considered in a descriptive sense only and not for purposes of limitation. Descriptions of features or aspects within each embodiment should typically be considered as available for other similar features or aspects in other embodiments.

1. An inter-layer video decoding method comprising:
obtaining prediction mode information of a depth image;
generating a prediction block of a current block forming the depth image, based on the obtained prediction mode information; and
decoding the depth image by using the prediction block,
wherein the obtaining of the prediction mode information comprises obtaining a first flag, which indicates whether the depth image allows a method of predicting the depth image by splitting blocks forming the depth image into at least two partitions using a wedgelet as a boundary, and a second flag, which indicates whether the depth image allows a method of predicting the depth image by splitting the blocks forming the depth image into at least two partitions using a contour as a boundary.

2. The inter-layer video decoding method of claim 1, wherein the obtaining of the prediction mode information comprises further obtaining, from the first flag, information about whether the depth image allows a method of predicting the depth image by using an intra simplified depth coding (SDC) mode.

3. The inter-layer video decoding method of claim 2, wherein the obtaining of the prediction mode information further comprises obtaining a third flag comprising information about whether the depth image allows a method of predicting the depth image by using an inter SDC mode.

4. The inter-layer video decoding method of claim 3, wherein the obtaining of the prediction mode information comprises:
when the first flag has a value of 1, determining that the depth image allows at least one of the method of predicting the depth image by splitting the blocks forming the depth image into at least two partitions using the wedgelet as the boundary and the method of predicting the depth image by using the intra SDC mode, and when the first flag has a value of 0, determining that the depth image does not allow the method of predicting the depth image by splitting the blocks forming the depth image into at least two partitions using the wedgelet as the boundary and the method of predicting the depth image by using the intra SDC mode;
when the second flag has a value of 1, determining that the depth image allows the method of predicting the depth image by splitting the blocks forming the depth image into at least two partitions using the contour as the boundary, and when the second flag has a value of 0, determining that the depth image does not allow the method of predicting the depth image by splitting the blocks forming the depth image into at least two partitions using the contour as the boundary; and
when the third flag has a value of 1, determining that the depth image allows the method of predicting the depth image by using the inter SDC mode, and when the third flag has a value of 0, determining that the depth image does not allow the method of predicting the depth image by using the inter SDC mode.

5. The inter-layer video decoding method of claim 4, wherein the obtaining of the prediction mode information comprises, when at least one of the first and second flags has a value of 1, obtaining a fourth flag indicating whether a method of predicting the depth image by splitting the current block into at least two partitions according to a pattern is allowed.

6. The inter-layer video decoding method of claim 5, wherein the obtaining of the prediction mode information comprises, when it is determined that the method of predicting the depth image by splitting the current block into at least two partitions is allowed based on the obtained fourth flag, obtaining a fifth flag comprising information about a type of a method of splitting the current block, and
wherein the fifth flag specifies one of a method of splitting the current block by using a wedgelet and a method of splitting the current block by using a contour.

7. The inter-layer video decoding method of claim 5, wherein the obtaining of the prediction mode information comprises, when it is determined that the method of predicting the depth image by splitting the current block into at least two partitions is allowed based on the obtained fourth flag, specifying a type of a method of splitting the current block as one of a method of splitting the current block by using a wedgelet and a method of splitting the current block by using a contour, based on the obtained first and second flags.

8. The inter-layer video decoding method of claim 4, wherein the obtaining of the prediction mode information comprises:
determining whether the depth image allows using of an SDC mode; and
when it is determined that the depth image allows the SDC mode, obtaining a sixth flag indicating whether an SDC mode of the current block is allowed.

9. The inter-layer video decoding method of claim 8, wherein the determining of whether the depth image allows the SDC mode comprises:
when a prediction mode of the current block is an inter mode, a partition mode of the current block is 2N×2N, and the third flag has a value of 1, determining that the depth image allows the using of the SDC mode;
when the prediction mode of the current block is an intra mode, the partition mode of the current block is 2N×2N, and the first flag has a value of 1, determining that the depth image allows the using of the SDC mode; and
when the prediction mode of the current block is a skip mode, determining that the depth image does not allow the using of the SDC mode.

10. The inter-layer video decoding method of claim 5, wherein the obtaining of the fourth flag comprises decoding the fourth flag by using one independent context model for performing context-based adaptive binary arithmetic code (CABAC) decoding on the fourth flag.

11. The inter-layer video decoding method of claim 7, wherein the obtaining of the sixth flag comprises decoding the sixth flag by using one independent context model for performing context-based adaptive binary arithmetic code (CABAC) decoding on the sixth flag.

12. An inter-layer video encoding method comprising:
determining a prediction mode of a depth image;
generating a prediction block of a current block forming the depth image by using the determined prediction mode; and
encoding the depth image by using the prediction block,
wherein the determining of the prediction mode comprises generating a first flag, which indicates whether the depth flag allows a method of predicting the depth image by splitting blocks forming the depth image into at least two partitions using a wedgelet as a boundary, and a second flag, which indicates whether the depth image allows a method of predicting the depth image by splitting the blocks forming the depth image into at least two partitions using a contour as a boundary.

13. An inter-layer video decoding apparatus comprising:
a prediction mode determiner configured to obtain prediction mode information of a depth image;
a prediction block generator configured to generate a prediction block of a current block forming the depth image based on the obtained prediction mode information; and
a decoder configured to decode the depth image by using the prediction block,
wherein the prediction mode determiner obtains a first flag, which indicates whether the depth image allows a method of predicting the depth image by splitting blocks forming the depth image into at least two partitions using a wedgelet as a boundary, and a second flag, which indicates whether the depth image allows a method of predicting the depth image by splitting the blocks forming the depth image into at least two partitions using a contour as a boundary.

14-15. (canceled)
